(19) United States
(12) Patent Application Publication
(10) Pub. No.: US 2005/0208412 A1
(43) Pub. Date: Sep. 22, 2005

(54) Image forming method

(75) Inventors: Eisuke Iwazaki, Minamiashigara-shi (JP); Takao Ishiyama, Minamiashigara-shi (JP); Masakazu Iijima, Minamiashigara-shi (JP); Tomohito Nakajima, Minamiashigara-shi (JP); Satoshi Yoshida, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/951,943

(22) Filed: Sep. 29, 2004

(30) Foreign Application Priority Data
Mar. 19, 2004 (JP) 2004-81495

(51) Int. Cl. G03G 9/08

(52) U.S. Cl. 430/110.1; 430/108.7; 430/110.3; 430/124

(57) ABSTRACT

The present invention provides a toner having a releasing agent, a binder resin and a colorant. The binder resin is contained in a form of particles, surfaces of which have 1.2 times or greater amount of a polar group-containing compound, or of a cross-linked compound, than insides thereof. A viscosity of the releasing agent, as determined by using a type-E viscometer provided with a cone plate having a cone angle of 1.34 degrees at 140° C., is 1.5 to 5.0 mPa·S. The present invention further provides a developer containing a carrier and the toner. The present invention further provides an image forming method that utilizes the developer.

### CROSS-REFERENCE TO RELATED APPLICATION

This application claims priority under 35USC 119 from Japanese Patent Application No. 2004-81495, the disclosure of which is incorporated by reference herein.

### BACKGRGOUND OF THE INVENTION

1. Field of the Invention

The present invention relates to method of forming images by developing and fixing images with the use of a developer containing a toner, a developer that develops electrostatic latent images which are formed by an electrophotographic, or electrostatic-recording method, or by the similar method.

2. Description of the Related Art

Methods such as electrophotographic and other processes, which visualize image information by means of electrostatic charged images, are currently used in various fields. In such electrophotographic processes, images are visualized by forming, by means of charging and exposing processes, an electrostatic charged image on a photoreceptor, by developing, with a developer containing a toner, an electrostatic latent image formed thereon, and by the image-transferring and fixing.

Two-component developers comprising a toner and a carrier, and one-component developers that employ only one magnetic or non-magnetic toner are known as developers for use in such systems. Moreover, a kneading-pulverizing process, wherein a thermoplastic resin is melt-kneaded with a pigment, a charge-controlling agent, and a releasing agent such as a wax, and the resulting mixture is then pulverized and classified after cooling, is also commonly used as a method of producing the toners. Inorganic or organic particles for improvement in fluidity and cleanability are, whenever necessary, occasionally added to the toner particle surface.

Although manufacturing process described above can be effective in producing reasonably superior toners, they still entail a number of problems which are described below.

First, in normal kneading-pulverizing processes, the shape and the surface structure of toners produced are amorphous, and it is difficult to control consciously the shape and surface structure of the toners, although to some extent they may be altered by adjusting both the grindability of raw materials used and conditions prevailing during pulverization. In addition, the range of materials which can be selected for the kneading-pulverizing process is limited. Specifically, a resin colorant dispersion should be sufficiently brittle and capable of being pulverized in a manufacturing device which is viable economically feasible.

However, in order to satisfy the above requirements, a resin colorant dispersion is made brittle, a toner obtained therefrom may generate finer powders as a result of a mechanical shearing force generated in the developing device, or it may cause a change in the shape of the toner. In two-component developers, for example, reduction in the level of charges on the developer can be further triggered because of the adhesion of fine powders to the carrier surface as a result of such these influences, while in one-component developers, toners may scatter more easily due to an expansion in grain size distribution. There also tends to be an increased incidence of deterioration in image quality caused by a diminished level of developing efficiency caused by the change in toner shape.

When a toner is produced by adding internally a large amount of a releasing agent such as a wax, exposure of the releasing agent on the toner surface is often affected, depending on the kind of thermoplastic resin which is used in combination with the releasing agent. In particular, a combination of a relatively difficult to pulverize resin having a high molecular weight component, and thus having a higher degree of elasticity, and a brittle wax such as polyethylene, often causes the exposure of polyethylene on the toner surface. Such a toner has advantages in terms of toner-releasing characteristics, and insofar that cleaning of an untransferred toner on a photoreceptor surface during image fixation is facilitated. However, as a result of the mechanical force, the polyethylene on the surface of the toner migrates more easily, thus contaminating the developing rolls, the photoreceptor and carriers, and in consequence leading to a deterioration in reliability.

As the toner shape is amorphous, even when an fluidity-improving aid is added, the toner is sometimes not sufficiently fluid. The fluidity of the toner accordingly diminishes over time due to the migration of particles into dents on the toner surface caused by a mechanical shearing force during use, or because, as a result of the embedding of the fluidity-improving aid into the toner, there is a deterioration in developing property, transferability, or cleanability. In addition, recycled use in a developing machine of a toner recovered after being once used for cleaning tends to cause a further deterioration in image quality. If an amount of fluidity-improving aid is further increased in order to prevent the kind of problems described above, black spots often appear on the photoreceptor, and aid particles can scatter.

In recent years, methods of producing toners by an emulsion polymerization coagulation process have been proposed as a means of consciously controlling the shape and surface structure of toners (e.g., Japanese Patent Application Laid-Open (JP-A) Nos. 63-282752 and 6-250439).

In general, these are methods of producing toners by preparing a resin dispersion by means of an emulsion polymerization or the like; separately, preparing a colorant dispersion wherein a colorant is dispersed in a solvent, forming aggregates corresponding to toner particles by mixing these dispersions; and by then fusing the aggregates by means of heating.

Although according to this method the shape of toners may to some extent be controlled, and the electrostatic property and durability thereof may be improved, the toners have an almost uniform inner structure, a fact which can often lead to a deterioration in the melt-exudation property of releasing agent components at a time image fixation. Accordingly, further stability is required to prevent a deterioration in the oil-less releasability of an image-fixing substrate, and enhanced stability of transparency in fixed images which are output by using an OHP film.

To obtain stabilization of releasability, it is desirable to make a releasing agent component such as a wax exude more easily during image fixation, and such improvements have hitherto been accomplished by lowering the melting point of releasing agent components, by narrowing down the molecular weight distribution thereof, or by reducing the molecular weight thereof. However, although a melt-exudation property may to some degree be improved, the methods described above cause an increase in the amount of low-molecular weight components, thus causing the co-melting of the binder resin component and the low-molecular weight components. In turn this can sometimes causes a deterioration in the stringiness of the toner at a time of melting, and on occasions a deterioration in a hot offsetting property at a high temperature range. Additionally, these methods can cause marks generated by contact with the delivery rolls during discharge of the image-fixed sheets (hereinafter, on occasion referred to as “roll marks”), thus inhibiting formation of high-quality fixed images. This phenomenon has proved to be ever more prevalent in the case of images of high-glossiness.

Alternatively, a releasing agent employing a metallocene catalyst has been proposed as a method of raising the melting point, and of lowering the viscosity of releasing agents (e.g., JP-A No. 08-248671).

However, use of a releasing agent is preferable in the case of high-pressure low-speed fixing systems such as two-roll fixing systems, as acid anhydrides commonly used as the copolymer have a relatively higher viscosity. However, for example, in energy-saving type fixing systems, the releasing agent is not effectively melt-exuded, and a trend of results obtained suggests that in consequence in such circumstances the releasing agent cannot provide fixed images of acceptable quality (e.g., JP-A No. 2001-75392).

In addition, application of an ester-based releasing agent low in crystallinity has been proposed for the prevention of roll marks, and for an improvement in the transparency of overhead projector (OHP) images (e.g., JP-A No. 6-337541).

However, in such a case, the binder resin component and the ester-based releasing agent co-melt and become plastic, frequently causing a deterioration in the hot offsetting property at a high temperature range. It is possible to overcome to some degree the transparency problem derived from the releasing agent, by introducing a cross-linking structure into the binder resin to suppress the plasticity. However, the melt fluidity of the toner itself is lowered during toner image fixation, and thus it is difficult to apply this method in the case of images of a high glossiness.

As described above, in the course of electronic photograph processes, in order to maintain stability even when the toner is subjected to various mechanical stress, it is desirable to suppress the exposure of the releasing agent on the surface, to raise the level of surface hardness without sacrificing fixability, to increase the mechanical strength of the toner itself, and to provide the toner with well-balanced electrostatic property and fixability.

Reflecting the need for high-quality images, in redent years there has been a drastic shift toward toners of a small diameter for realization of images of high-definition, especially color images of high-definition. However, merely by reducing the diameter of toners and at the same time maintaining conventional grain size distribution, it is difficult to obtain images of a high quality and at the same time high reliability. This is because the presence of fine-powder toners exacerbates problems such as the staining of carriers and the photoreceptor, and the scattering of the toner. To prevent this, it is necessary to sharpen the grain size distribution, and to make possible a reduction in particle diameter.

Recently, in digital full-color copying machines and printers, a color-image on documents is divided into B (blue), R (red), and G (green) images by using appropriate color filters, and latent images corresponding to the appropriate divided original images comprising dots of 20 to 70 μm in diameter are developed with Y (yellow), M (magenta), C (cyan), and Bk (black) developers. Thus, by mixing these developers an image in original color is formed. Accordingly, in such systems, the developer should be transferred in amounts greater than in the conventional black and white systems, and should also be compatible with dots smaller in diameter. Uniform electrostatic property, consistency of performance, toner strength, and sharpness of grain size distribution are thus becoming increasingly important.

Considering the demand for increased speed and energy-conservation in these machines, toners now need to be fixed at increasingly lower temperatures. From these points of view the coagulation-fusion toners described above have superior properties which are suitable for production of toners sharper in grain size distribution and smaller in particle diameter.

In the case of toners for use in full-color machines, multiple toners of different colors need to be mixed, and at this time it is also desirable to improve color reproducibility and OHP transparency during use.

Generally for prevention of low-temperature offsetting during image fixation, a polyolefin wax is added internally to releasing agent components. At the same time, to secure an improvement in a high-temperature offsetting property, a small amount of a silicone oil is uniformly applied onto the fixing roller. As a result, silicone oil usually sticks to the image-transferred substrates discharged, making it unpleasant to handle the substrates, and silicone oil is thus best avoided.

For these reasons, a toner for oil-less fixing that contains a greater amount of a releasing agent component therein has been proposed (e.g., JP-A No. 5-061239).

However, although in such a case the addition of a large amount of releasing agent produces a modest improvement in releasability, the binder component and the releasing agent therein co-melt, making exudation of the releasing agent uneven and thus leading to poor releasing stability. Additionally, because the means of controlling the cohesive capacity of the toner binder resin depends on the weight-average molecular weight (Mw) and grass transition point (Tg), it is difficult to control directly the stringiness and aggregation capacity of the toner during image fixation. Further, components exuded from the releasing agent are sometimes the cause of electrification inhibition.

As a film is formed on images with substantial amounts of releasing agent exuded during image fixing, when the substrates carrying the fixed images come into contact with pinch rolls and delivery rolls during discharge, thus contact occasionally produces image defects, i.e., marks on fixed images caused by contact, (hereinafter, referred to as “roll marks”) and on occasions this results in a deterioration in image quality.

### SUMMARY OF THE INVENTION

In view of the problems associated with conventional toners described above, the present invention provides a novel image forming method.

That is, the invention provides an image forming method in which, when an OHP sheet is used as an image-fixing substrate, a superior level of releasability of the substrate during oil-less fixing is maintained and fixed images are produced which are superior in fixing characteristics such as surface glossiness and OHP transparency, without any obvious delivery roll marks being generated during discharge of the fixed image-carrying substrate, and which have a fine image quality.

After intensive studies of problems in the related art, the present inventors have accomplished the present invention.

A first aspect of the invention is a toner comprising a releasing agent, a binder resin and a colorant, wherein the binder resin is contained in a form of particles, surfaces of which have 1.2 times or greater amount of a polar group-containing compound, or of a cross-linked compound, than insides thereof, and a viscosity of the releasing agent, as determined by using a type-E viscometer provided with a cone plate having a cone angle of 1.34 degrees at 140° C., is 1.5 to 5.0 mPa·S.

A second aspect of the invention is a developer containing a carrier and the toner.

A third aspect of the invention is an image forming method comprising: transferring a toner image onto an image-fixing substrate by using the developer containing the toner; fixing the transferred toner image; and discharging the fixed toner image-carrying substrate with delivery rolls, wherein a haze Ha of a toner image which is brought into contact with the delivery rolls during the discharging, and a haze Hb of a toner image which is not brought into contact with the delivery rolls during the discharging, satisfy the following Formulae (1) to (3).
0.3%≦Ha≦30%; Formula (1)
0.3%<Hb≦30%; and Formula (2)
0<|Ha−Hb|≦8% Formula (3)

### DETAILED DESCRIPTION OF THE INVENTION

The image forming method according to the present invention comprises transferring a toner image onto an image-fixing substrate by using a developer containing a toner including a releasing agent, a binder resin and a colorant, fixing the transferred toner image, and discharging the fixed toner image-carrying substrate by delivery rolls, wherein during the discharge of the fixed toner image-fixed substrate by the delivery rolls, a haze Ha of a toner image which is brought into contact with the delivery roll and a Hb of a toner image which is not brought into contact with the delivery roll satisfy the following Formulae (1) to (3).

(In the invention, the delivery rolls are a pair of rolls made up of an end roll and a pinch roll.)
0.3%≦Ha≦30%; Formula (1)
0.3%≦Hb≦30%; and Formula (2)
0<|Ha−Hb I≦8%. Formula (3)

In other words, the image forming method according to the invention is an image forming method for forming an image on an image-fixing substrate, such as an OHP sheet, a method that suppresses delivery roll marks generated between the delivery and areas which are in contact with the delivery rolls, roll marks which can occur on the toner images which are fixed on the image-fixing substrate and which are formed at least after the transfer, fixing and discharge processes. When a haze value, corresponding to the extent to which delivery roll marks of the type described above exist, satisfies Formulae (1) to (3), this means that the delivery roll marks described above are not particularly conspicuous.

The image forming method according to the invention is aimed at reducing the adverse effects of contact with the delivery rolls, i.e., reducing as fas as is possible the |Ha−Hb| value to zero, and is characteristic in that the method satisfies the condition of 0<|Ha−Hb|≦8%, as shown in Formula (3) above, preferably 0<|Ha−Hb|≦6%, and more preferably 0<|Ha−Hb|≦3%.

If |Ha−Hb| is more than 6% and 8% or less, delivery roll mark are only slightly detectable by visual observation; if |Ha−Hb| is more than 4% and 6% or less, the delivery roll marks are almost undetectable by visual observation; and if |Ha−Hb| is 3% or less, delivery roll marks are not detectable at all.

On the other hand, when |Ha−Hb| is greater than 8%, delivery roll marks are clearly detectable by visual observation.

As shown in Formulae (1) and (2), the image forming method according to the invention is also characteristic insofar that it satisfies the conditions of 0.3%≦Ha≦30% and 0.3%≦Hb≦30%, and both Ha and Hb are preferably 6% or more and 25% or less and more preferably 8% or more and 13% or less. When Ha and Hb are less than 0.3%, even when the amount of releasing agent on the fixed image surface is reduced, as glossiness is extremely high, delivery roll marks become more prevalent; and if Ha and Hb are greater than 30%, the degree of transparency is reduced, resulting in an undesirable deterioration in color image quality.

In the image forming method according to the invention, one method for satisfying Formulae (1) to (3) is to adjust to within a range of about 0.5 to 2.0 μm the thickness of the layer formed by above-mentioned releasing agent in the toner image which has been fixed. If the thickness of the releasing agent layer is less than about 0.5 μm, it is on occasions difficult to release the image-fixed substrate consistently and thus to obtain images of high glossiness. On the other hand, if the thickness of the releasing agent layer is more than about 2.0 μm, delivery roll marks may become more prevalent.

In the invention, the thickness of the releasing agent layer can be determined by a scanning electron microscope (SEM) observation of a cross section of fixed toner images. Specifically, a fixed toner image on an image-fixing substrate to be measured is together with the image-fixing substrate cut into pieces, and a piece is deposited with gold or the like according to a common method. At this time the releasing agent may also be stained with ruthenium or the like. The magnification of the microscope may be set at an arbitrary rate as long as observation is possible, but is preferably 10,000 fold. The thickness of the releasing agent layer is obtained by determining the thickness of the releasing agent layer several times at intervals of 3 μm on the layer determined by means of SEM and then averaging the thicknesses.

The releasing agent layer described above is a layer formed on the surface of toner images with the releasing agent exuded from the toner during fixing of the toner images. Together with the releasing agent, the releasing agent layer may contain small amounts of other components. The releasing agent layer can be clearly differentiated from other layers by means of SEM observation.

In the process of fixing according to the invention, images are fixed by bringing an image-fixing substrate, on the surface of which a toner containing a releasing agent is adhered, into contact with a heated fixing member and thus fusing the toner. A contact time between the toner and the fixing member is usually expressed by a contact width between the fixing member and a pressurizing member, and normally by a ratio of the nip width and the passing speed of the image-fixing substrate, as expressed in the following formula:
(Contact time)=(Nip width)/(Passing speed of image-fixing substrate).

For example, if the nip width is 6 mm and the passing speed of the image-fixing substrate is 180 mm/sec, the contact time is 6/180=0.0333 sec. The contact time may occasionally be referred to as nip time, image-fixing time, or heating time.

As during the period of contact, the toner is fused, the level of its viscosity is lowered, and the toner penetrates into the substrate, images are fixed on the image-fixing substrate. For obtaining fixed images of high glossiness, it is desirable to lower the degree of viscosity of the toner during the contact period and thus enhance the surface smoothness of fixed images. When on the other hand the degree of viscosity decreases significantly, the aggregation capacity of a toner constituent, the binder resin, diminishes significantly, resulting in migration of a part of the toner to the fixing members, and leading to so-called hot offsetting. To prevent this hot offsetting, it is common practice to expand the region where fixing is possible. This is achieved by enhancing the release characteristics of toner image-carrying substrates, by means of adding during the contact period a low temperature-melting releasing agent to the toner, thus allowing the releasing agent to melt before the degree of viscosity of the toner is lowered, and thus to exude to the interface between the toner and the fixing members. In the case of full-color images that demand a substantial amount of toner adhered on the image-fixing substrate, and a high degree of glossiness in printed images, the amount of releasing agent contained in the toner becomes larger and the releasing agent spreads over the entire region of the fixed images.

The releasing agents are normally crystalline, and because the degree of viscosity is reduced rapidly at a temperature of melting point or higher, the releasing agent enhance the release characteristics of the fixed image-carrying substrates described above. On the other hand, after contact, i.e., after passing through the nip region, the fixed images are cooled by virtue of releasing, into the air and/or onto the image-fixing substrate, the heat which was applied for fixing images. At this time, the releasing agent recrystallizes, forming a layer on the fixed image surface.

It is believed that the delivery roll marks are likely to represent the difference in glossiness between areas in contact with delivery rolls and those areas not in contact. This is caused by a difference in cooling conditions, and thus in the crystalline states, of the two kinds of area, because the releasing agents of fixed images on the image-carrying substrates which are discharged from the nip region cool rapidly as a result of contact with the roll portions of delivery rolls for discharging the substrates, whereas releasing agents which are not in contact with the delivery rolls cool relatively slowly.

Accordingly, delivery roll marks are more frequently observed under conditions where fixed at a high glossiness are formed images, and irrespective of the image-fixing substrate used invariably appear under certain conditions of high glossiness.

Because the length of time that transparent films, such as OHP sheets and the like, are in contact with fixing members is longer than in these case of papers and the like, in order to enhance transparency of fixed transparency images, the difference between contact and non-contact areas in terms of a drop in temperature brought about by contact with delivery rolls becomes more significant. Thus, a difference in the degree of a crystalline state tends to expand, and thus in turn leads to a conspicuous number of delivery roll marks.

In the invention, as described above, the thickness of the releasing agent layer on the fixed toner image is preferably adjusted to about 0.5 to 2.0 μm, by means of methods described below. The thickness of the releasing agent layer is more preferably about 0.8 to 1.6 μm and still more preferably about 0.9 to 1.3 μm.

The process of transferring according to the invention may be any one of commonly used transferring methods except insofar that use of a developer containing a toner described below is desirable for making a thickness of the releasing agent layer within a range of about 0.5 to 2.0 μm. Examples of transferring methods include those described in JP-A Nos. 8-171290, 9-114279, 11-153914, and 11-24427.

In addition, an image-fixing substrate for use in the invention is not particularly limited as long as it is an OHP sheet. In general terms the smoother the surface of an image-fixing substrate, the more likely it is to generate delivery roll marks. This is because images of high glossiness are formed more easily and at the same time, on a smooth image-fixed substrate the difference in temperature between areas in contact with the delivery rolls and those not in contact with delivery rolls becomes more accentuated.

The toner for use in the invention comprises a releasing agent, a binder resin and a colorant. The binder resin has 1.2 times or larger percentage of a polar group-containing compound (e.g., a carboxyl group-containing compound such as acrylic acid) and/or a cross-linked compound (an aliphatic cross-linking compound) on its surface than on the inside thereof. Use of a toner containing a binder resin having a polar group-containing compound and/or a cross-linked compound with a higher percentage of contents on the surface than on the inside facilitates formation on fixed toner images of a releasing agent layer with a thickness of about 0.5 to 2.0 μm. The toner for use in the invention more preferably has a polar group-containing compound and a cross-linked compound which both have a higher percentage of contents on the surface than on the inside. This is thought to be because a polar group-containing compound and/or a cross-linked compound increase the polarity and viscosity of toners more significantly on the surface than on the inside, and the exudation of a releasing agent molten by heating is suitably regulated by a surface which has both high polarity and high viscosity.

Hereinafter, methods of producing the toners will be described.

A method for producing toners for use in the invention is not particularly limited, but is preferably a method capable of providing a polar group and a cross-linking component on the toner surface, and particularly preferably an emulsion polymerization aggregationprocess. The emulsion polymerization aggregationprocess is a method of producing toners, comprising: preparing a liquid mixture by blending a binder resin particle dispersion wherein binder resin particles having a particle diameter of around 1 μm or less are dispersed, a colorant dispersion wherein a colorant is dispersed, and a releasing agent dispersion wherein releasing agents are dispersed; aggregatingdispersants in the mixed solution by adding a coagulant to the mixed solution to form aggregate particles; and coalescing the aggregate particles by heating them at a temperature of a glass transition point of the binder resin particles, or higher.

The resin particles mentioned above may be produced, for example, by an emulsion polymerization or similar process. Emulsion polymerization provides binder resin particles, for example, by adding a number of polymerizable monomers together with a dispersion stabilizer such as a surfactant, to a solvent having a relatively higher polarity, such as water, thus forming micelles in the dispersion medium, and then initiating polymerization by the further addition of a water-soluble polymerization initiator into the micellar solution. At this time, polymerizable monomers with a higher degree of hydrophilicity, or of polarity in micelles, are localized on the surfaces of the micelles, in other words, at an interface with the solvent, thus stabilizing the inner structure of the micelles. When polymerization is initiated with a polymerization initiator, it is polymerizable monomers that are lower in polarity which tend to be more readily polymerized. The reason for this is probably because polymerizable monomers which have a higher degree of polarity become less reactive in polymerization because the 1-electrons in the polymerizable monomers which have polarity are withdrawn by the electron-withdrawing polar group therein.

By making use of the property described above, it is possible to position in the neighborhood of the surfaces of resin particles polymerizable monomers in the micelles which have a high degree of polarity; and when the polymerizable monomers which have high degree of polarity are cross-linkable, it is possible to produce toners which have polar group-containing, and cross-linked, compounds in greater amounts at the surface than on the inside.

In the coagulating process, aggregate particles are formed by preparing a liquid mixture by means of blending a binder resin particle dispersion, a colorant dispersion, and a releasing agent dispersion in which a releasing agent is dispersed, and by then adding a coagulant to the liquid mixture. The aggregate particles are formed by a process such as heteroaggregation, and for purposes of stabilizing the aggregate particles and controlling the diameter and grain size distribution, an ionic surfactant with a polarity different to that of the aggregate particles, or a compound having a monovalent or higher-valent electric charge such as a metal salt, is often added to the aggregate particles.

In the process described above, the dispersions may all be blended at the same time for purposes of coagulation. Alternatively, the aggregate particles may be produced in the following manner: by first blending, in the process of coagulation, imbalanced amounts of ionic dispersants which have varying degree of polarity at an initial stage; neutralizing the resulting dispersion ionically by using an ionic surfactant or a compound having a monovalent or higher-valent electric charge such as a metal salt; forming, and then stabilizing core aggregates produced during the first stage by heating them at a temperature of a glass transition point or lower; in a second stage adding particle dispersions which have previously been treated with polarity and volume dispersants and which correct the imbalances described above; further heating as and when necessary the liquid mixture at a temperature of the glass transition point, or lower, of the resin contained in the core, or in the particle added and then stabilizing the resultant particle dispersion at an even higher temperature; an by heating the liquid mixture at a temperature higher than the glass transition point; coalescing the particles which have been added during the second stage of the coagulation process on the surface of the core aggregate particles as they are adhered. Further, the step by step procedures of coagulation which have been described above may be repeated several times.

In the invention, if a polyester is used as the binder resin, the polyester after preparation may be dispersed together with a dispersion stabilizer under high-temperature and high-pressure conditions, thus producing a resin particle dispersion. In such a case, the introduction of polar groups into the polyester resin enables migration of the polar group to the neighborhood of the surface and thus the production of resins having the advantages of the invention.

As an alternative production method of the toners for use in the invention, a suspension polymerization process may also be preferably used. The suspension polymerization process is a method of forming toner particles by suspending colorant particles and then releasing agent particles and the like, together with polymerizable monomers, in an aqueous medium to which a dispersion stabilizer or the like is as and when required added; dispersing the mixture so as to make the suspended materials into a desired particle diameter and grain size distribution; polymerizing the polymerizable monomers, for example by means of heating; separating the polymer from the aqueous medium, and washing and drying as and when required.

In the case of the suspension polymerization process involving the addition of polymerizable monomers to the aqueous medium as described above, use of polymerizable monomers with a high degree of polarity as well as polymerizable monomers having a high cross-linking capacity produce effects similar to those described above.

Specific examples of polymerizable monomers include homopolymers or copolymers of styrenes such as styrene, p-chlorostyrene, and α-methylstyrene; homopolymers or copolymers of vinyl group-containing esters such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; homopolymers or copolymer of vinyl nitriles such as acrylonitrile and methacrylonitrile; homopolymers or copolymers of vinylethers such as vinylmethylether and vinylisobutylether; homopolymers or copolymers of vinylmethylketone, vinylethylketone and vinylisopropenylketones; homopolymers or copolymers of olefins such as ethylene, propylene, butadiene, and isoprene; and the like.

Among the polymerizable monomers listed above, polymerizable monomers having a high degree of polarity include methyl acrylate, ethyl acrylate, n-propyl acrylate, n-butyl acrylate, methyl methacrylate, ethyl methacrylate, n-propyl methacrylate, acrylonitrile, and methacrylonitrile.

Additional examples of polymerizable monomers include silicone resins such as methylsilicone and methylphenylsilicone; polyesters containing bisphenol or glycol; epoxy resins, polyurethane resins, polyamide resins, cellulose resins, polyether resins, polycarbonate resins.

These resins may be used alone or in combinations of two or more.

Among the polymerizable monomers mentioned above, specifically, copolymers of styrenes such as styrene, p-chlorostyrene and α-methylstyrene, short-chain alkyl acrylate esters such as methyl acrylate and methyl methacrylate, and the like; and n-propyl acrylate, n-butyl acrylate, lauryl acrylate, 2-ethylhexyl acrylate, n-propyl methacrylate, lauryl methacrylate, 2-ethylhexyl methacrylate and the like are preferably used.

Specific examples of cross-linking agents for cross-linking the polymerizable monomers include aromatic polyvinyl compounds such as divinylbenzene and divinylnaphthalene; aromatic polyvalent carboxylic polyvinylesters such as divinyl phthalate, divinyl isophthalate, divinyl terephthalate, divinyl homophthalate, divinyl/trivinyl trimesate, divinyl naphthalenedicarboxylate, and divinyl biphenylcarboxylate; divinyl esters of nitrogen-containing aromatic compounds such as divinyl pyridinedicarboxylate; vinyl esters of unsaturated heterocyclic carboxylic acids such as piromucin acid vinyl, vinyl furancarboxylate, vinyl pyrrole-2-carboxylate, and vinyl thiophenecarboxylate; straight-chain polyvalent alcohol (meth)acrylate esters such as butanediol methacrylate, hexanediol acrylate, octanediol methacrylate, decanediol acrylate, and dodecanediol methacrylate; branched-chain substituted polyvalent alcohol (meth)acrylate esters such as neopentylglycol dimethacrylate and 2-hydroxy-1,3-diacryloxy propane; polyethylene glycol di(meth)acrylates and polypropylene polyethylene glycol di(meth)acrylates; polyvalent carboxylic polyvinylesters such as divinyl succinate, divinyl fumarate, vinyl/divinyl maleate, divinyl diglycolate, vinyl/divinyl itaconate, divinyl acetonedicarboxylate, divinyl glutarate, divinyl 3,3′-thiodipropionate, divinyl/trivinyl trans-aconitate, divinyl adipate, divinyl pimelate, divinyl suberate, divinyl azelate, divinyl sebacate, divinyl dodecanedicarboxylate, and divinyl brassylate; and the like.

In this specification, “(meth)acrylates” mean “acrylates and methacrylates”, and a “(meth)acryl” group means an “acryl and methacryl” group.

In the invention, the cross-linking agents may be used alone or in combinations of two or more. Among cross-linking agents, the cross-linking agent according to the invention is preferably polymerized slower than normal polymerizable monomers. Preferable examples of such cross-linking agents include straight-chain polyvalent alcohol (meth)acrylate esters such as butanediol methacrylate, hexanediol acrylate, octanediol methacrylate, decanediol acrylate, and dodecanediol methacrylate; branched-chain substituted polyvalent alcohol (meth)acrylate esters such as neopentylglycol dimethacrylate, and 2-hydroxy-1,3-diacryloxypropane; polyethylene glycol di(meth)acrylate; polypropylene polyethylene glycol di(meth)acrylate; and the like.

The content of the cross-linking agent mentioned above is preferably in a range of about 0.05 to 5% by weight and more preferably in a range of about 0.1 to 1.0% by weight, in relation to the total amount of polymerizable monomers.

When a binder resin for use in the toner according to the invention is produced by radical polymerization of a polymerizable monomer, the polymerization initiators for use in the process of polymerization include those mentioned below.

Radical polymerization initiators to be used in the process are not particularly limited. Specific examples thereof include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, triphenyl peracetate, tert-butyl hydroperoxide, tert-butyl performate, tert-butyl peracetate, tert-butyl perbenzoate, tert-butyl perphenylacetate, tert-butyl permethoxyacetate, and tert-butyl per-N-(3-toluyl)carbamate;

azo compounds such as 2,2′-azobispropane, 2,2′-dichloro-2,2′-azobispropane, 1,1′-azo(methylethyl)divinyl acetate, 2,2′-azobis(2-amidinopropane) hydrochloride, 2,2′-azobis(2-amidinopropane) nitrate salt, 2,2′-azobisisobutane, 2,2′-azobisisobutylamide, 2,2′-azobisisobutylonitrile, methyl 2,2′-azobis-2-methylpropionate, 2,2′-dichloro-2,2′-azobisbutane, 2,2′-azobis-2-methylbutylonitrile, dimethyl 2,2′-azobisisobutyrate, sodium 1,1′-azobis(1-methylbutylonitrile-3-sulfonate), 2-(4-methylphenyl azo)-2-methyl malonodinitrile, 4,4′-azobis-4-cyanovaleric acid, 3,5-dihydroxy methylphenylazo-2-methylmalonodinitrile, 2-(4-bromophenylazo)-2-allylmalonodinitrile, 2,2′-azobis-2-methylvaleronitrile, dimethyl 4,4′-azobis-4-cyanovalerate, 2,2′-azobis-2,4-dimethylvaleronitrile, 1,1′-azobiscyclohexanenitrile, 2,2′-azobis-2-propylbutylonitrile, 1,1′-azobis-1-chlorophenylethane, 1,1′-azobis-1-cyclohexanecarbonitrile, 1,1′-azobis-1-cycloheptanenitrile, 1,1′-azobis-1-phenylethane, 1,1′-azobiscumene, ethyl 4-nitrophenylazobenylcyanoacetate, phenyl azodiphenylmethane, phenylazotriphenylmethane, 4-nitrophenylazotriphenylmethane, 1,1′-azobis-1,2-diphenylethane, poly(bisphenolA-4,4′-azobis-4-cyanopentanoate), poly(tetraethylene glycol-2,2′-azobisisobutylate); 1,4-bis(pentaethylene)-2-tetrazen; 1,4-dimethoxycarbonyl-1,4-diphenyl-2-tetrazen; and the like.

Preferable among these polymerization initiators are water-soluble compounds. Specific examples thereof include hydrogen peroxide, acetyl peroxide, cumyl peroxide, tert-butyl peroxide, propionyl peroxide, benzoyl peroxide, peroxide chlorobenzoyl, dichlorobenzoyl peroxide, bromomethylbenzoyl peroxide, lauroyl peroxide, ammonium persulfate, sodium persulfate, potassium persulfate, and diisopropyl peroxycarbonate.

During the production of the toner for use in the invention, a surfactant may be used, for example, for stabilization of dispersion during the suspension polymerization process, and for stabilization during the emulsion polymerization coagulation process, of a resin-particle dispersion, a colorant dispersion, or a releasing agent dispersions.

Examples of surfactants include anionic surfactants such as sulfate ester salts, sulfonate salts, phosphate esters, and soaps; cationic surfactants such as amine salts and quaternary ammonium salts; nonionic surfactants such as polyethylene glycols, alkylphenol ethylene oxide adducts, and polyvalent alcohols; and the like. Among them, ionic surfactants are preferable, and anionic and cationic surfactants are more preferable.

In the toner used in the invention, anionic surfactants generally have a higher dispersion force and are thus superior in terms of dispersing resin particles and colorants. Accordingly, use of an anionic surfactant is preferable as the surfactant for dispersing releasing agents.

Additionally, a nonionic surfactant is preferably used in combination with an anionic or a cationic surfactant. These surfactants may be used alone, or in combinations of two or more.

Specific examples of anionic surfactants include fatty acid soaps such as potassium laurate, sodium oleate, and castor oil sodium; sulfate esters such as octyl sulfate, lauryl sulfate, lauryl ether sulfate, and nonylphenylether sulfate; sodium salts of alkylnaphthalenesulfonic acid such as triisopropylnaphthalene sulfonate and dibutylnaphthalenesulfonate; sulfonate salts such as naphthalenesulfonate formaline condensates, monooctylsulfosuccinate, dioctylsulfosuccinate, lauric amide sulfonate, and oleic amide sulfonate; phosphoric acid esters such as lauryl phosphate, isopropyl phosphate, and nonylphenylether phosphate; dialkylsulfosuccinate salts such as sodium dioctylsulfosuccinate; sulfosuccinate salts such as disodium laurylsulfosuccinate; and the like.

Specific examples of cationic surfactants include amine salts such as laurylamine hydrochloride, stearylamine hydrochloride, oleylamine acetate salt, stearylamine acetate salt, and stearylaminopropylamine acetate salt; quaternary ammonium salts such as lauryltrimethylammonium chloride, dilauryldimethylammonium chloride, distearyldimethylammonium chloride, lauryldihydroxyethylmethylammonium chloride, oleyl-bispolyoxyethylene-methylammonium chloride, lauroylaminopropyldimethylethylammonium sulfate, lauroylaminopropyldimethylhydroxyethylammonium perchlorate, alkylbenzenetrimethylammonium chlorides, and alkyltrimethylammonium chlorides; and the like.

Specific examples of nonionic surfactants include alkyl ethers such as polyoxyethylene octylether, polyoxyethylene laurylether, polyoxyethylene stearyletherr, and polyoxyethylene oleylether; alkylphenylethers such as polyoxyethylene octylphenylether and polyoxyethylene nonylphenylether; alkyl esters such as polyoxyethylene laurate, polyoxyethylene stearate, and polyoxyethylene oleate; alkylamines such as polyoxyethylene laurylaminoether, polyoxyethylene stearylaminoether, polyoxyethylene oleylaminoether, polyoxyethylene soy bean aminoether, and polyoxyethylene beef tallow aminoether; alkylamides such as polyoxyethylene lauric amide, polyoxyethylene stearic amide, and polyoxyethylene oleic amide; vegetable oil ethers such as polyoxyethylene castor oil ether and polyoxyethylene rapeseed oil ether; alkanol amides such as lauric diethanolamide, stearic diethanolamide, and oleic diethanolamide; sorbitan ester ethers such as polyoxyethylene sorbitan monolaurate, polyoxyethylene sorbitan monopalmeate, polyoxyethylene sorbitan monostearate, and polyoxyethylene sorbitan monooleate; and the like.

The content of the surfactants in the resin particle dispersion, the colorant dispersion, or the releasing agent dispersion is not particularly limited as long as the surfactants therein do not impair the effects of the invention, but in general in terms is modest in volume. Specifically, the content is preferably about 0.01 to 10% by weight, more preferably in a range of about 0.05 to 5%, and still more preferably in a range of about 0.1 to 2% by weight. If the content of the surfactant is less than about 0.01% by weight, each of the resin particle, colorant, and releasing agent dispersions may become unstable, resulting in coagulation or on occasions separation of particular particles due to differences in the degree of stability of indivisual particles during coagulation. If, on the other hand, the content of the surfactant is more than about 10% by weight, the grain size distribution of particles may widen, on occasions making it more difficult to control the particle diameter. In general terms, suspension-polymerized toner dispersions which are larger in diameter remain stable even when a small amount of surfactant is added.

Water-insoluble hydrophilic inorganic particles may also be used as the dispersion stabilizer for use in the suspension polymerization process. Examples of inorganic particles which can be used include silica, alumina, titania, calcium carbonate, magnesium carbonate, tricalcium phosphate (hydroxyapatite), clay, diatomaceous soil, and bentonite. Among them, calcium carbonate, tricalcium phosphate, and the like are preferable as they are easier to use in the forming process and desirable from the point of view of removing particles.

In addition, water-soluble polymers and other types of polymer which are solid at room temperature may also be used. Specific examples thereof include cellulose compounds such as carboxymethylcellulose and hydroxypropylcellulose, polyvinyl alcohol, gelatin, starch, and gum arabic.

If an emulsion polymerization coagulation process is used for production of the toner according to the invention, in the coagulation process, particles may be modified by regulating the pH of the dispersion to generate aggregates. At the same time a coagulant may be added in order to make the coagulation of particles more reliable, or faster, or to obtain aggregate particles which are narrower in grain size distribution.

A compound having a monovalent or higher-valent electric charge is preferable as the coagulant. Specific examples of such compounds include water-soluble surfactants such as the ionic and nonionic surfactants described above; acids such as hydrochloric acid, sulfuric acid, nitric acid, acetic acid, and oxalic acid; inorganic acid metal salts such as magnesium chloride, sodium chloride, aluminum sulfate, calcium sulfate, ammonium sulfate, aluminum nitrate, silver nitrate, copper sulfate, and sodium carbonate; aliphatic or aromatic acid metal salts such as sodium acetate, potassium formate, sodium oxalate, sodium phthalate, and potassium salicylate; phenol metal salts such as sodium phenolate; amino acid metal salts; aliphatic or aromatic amines inorganic acid salts such as triethanolamine hydrochloride and aniline hydrochloride.

Taking into account the need for stability of aggregate particles, the need for stability of the coagulant in response to heat and the passage of time, and the need for the coagulant to be removed at the time of washing, inorganic acid metal salts are preferable as the coagulant in terms of their properties and usability. Specific examples of coagulants include inorganic acid metal salts such as magnesium chloride, sodium chloride, aluminum sulfate, calcium sulfate, ammonium sulfate, aluminum nitrate, silver nitrate, copper sulfate, and sodium carbonate.

A preferable amount of these coagulants added may vary according to the electric charge they carry, but is in any case modest. The amount in the case of a monovalent charge-carrying coagulant is preferably about 3% by weight or less; a bivalent charge-carrying coagulant, about 1% by weight or less; and a trivalent charge-carrying coagulant, about 0.5% by weight or less. Because it is preferable to use coagulants in small amounts, it is preferable to use a compound with a high-valency electric charge.

Any known colorants may be used as the colorant for use in the invention.

Examples of black pigments include carbon black, copper oxide, manganese dioxide, aniline black, activated carbon, and non-magnetic ferrite, magnetite.

Examples of yellow pigments include chrome yellow, zinc yellow, yellow iron oxide, cadmium yellow, chromium yellow, Hanza Yellow, Hanza Yellow 10G, Benzidine Yellow G, Benzidine Yellow GR, threne yellow, quinoline yellow, and Permanent Yellow NCG.

Examples of orange pigments include red chrome yellow, molybdate orange, Permanent Orange GTR, pyrazolone orange, Vulcan Orange, Benzidine Orange G, Indanthren Brilliant Orange RK, and Indanthren Brilliant Orange GK.

Examples of red pigments include Bengala, cadmium red, red lead, mercury sulfide, Watchung Red, Permanent Red 4R, Lithol Red, Brilliant Carmine 3B, Brilliant Carmine 6B, Du Pont Oil Red, pyrazolone red, Rhodamine B Lake, Lake Red C, rose bengal, eoxine red, and alizarin lake.

Examples of blue pigments include iron blue, cobalt blue, alkali blue lake, Victoria blue lake, Fast Sky Blue, Indanthren blue BC, aniline blue, ultramarine blue, Calco Oil Blue, methylene blue chloride, phthalocyanine blue, phthalocyanine green, and malachite green oxalate.

Examples of purple pigments include manganese purple, Fast Violet B, and methyl violet lake.

Examples of green pigments include chromium oxide, chromium green, Pigment Green, malachite green lake and Final Yellow Green G.

Examples of white pigments include zinc white, titanium oxide, antimony white, and zinc sulfide. Examples of extender pigments include barytes, barium carbonate, clay, silica, white carbon, talc, and alumina white.

Dyes may also be used as and when required. Examples of the dyes include various dyes including basic, acidic, dispersion and direct dyes, for example, nigrosin, methylene blue, rose bengal, quinoline yellow, and ultramarine blue. These dyes may be used alone or in a mixture, and the dyes may also be used in a solid solution state.

Dispersions of the colorant particles may be obtained with these coloring agents, for example, by using a dispersing machine. Examples of a dispersing machine include a dispersing medium such as a rotary shearing homogenizer, a ball mill, a sand mill, or an attritor; and a high-pressure counter collision dispersing machine.

Alternatively, by using a polar surfactant, it is possible to disperse these coloring agents in water by means of a homogenizer of the type mentioned above.

The coloring agents for use in the invention are suitably selected from the viewpoints of hue angle, color saturation, brightness, weather resistance, OHP transparency, and dispersibility within the toner. The amount of colorants added is preferably about 1 to 20 parts in relation to 100 parts by weight of the binder resin described above.

In contrast to other coloring agents, when a magnetic particle is used as the black coloring agent, the particles are preferably added in an amount of about 30 to 100 parts in relation to 100 parts by weight of the binder resin.

If a toner is preferably magnetic, magnetic powders may also be contained. Materials that become magnetized in a magnetic field, including ferromagnetic powders such as iron, cobalt, and nickel, and compounds such as ferrite and magnetite, may be used as magnetic powders.

In particular, as the toners are obtained in an aqueous phase in the invention, it is necessary to pay attention to the ability of magnetic particles to migrate into the aqueous phase. Thus, the magnetic particles are preferably subjected to a surface modification such as a hydrophobilization treatment.

The releasing agent in the toner according to the invention preferably has a maximum endothermic-peak temperature in a range of about 85 to 95° C., as determined by differential thermal analysis; a ratio of an area corresponding to a temperature of about 85° C. or less in the total endothermic peak, of about 5 to 15%; and an amount of releasing agent in the toner, which is determined by the peak height at the endothermic maximum, of about 6 to 9% by weight.

The maximum endothermic-peak temperature is preferably about 86 to 93° C.

If the maximum endothermic-peak temperature is less than about 85° C., the melt viscosity of the releasing agent is diminished, and although the melt-exudation property of the releasing agent improves during oil-less fixing, the releasing agent melts during production of the toner, leading to not only a reduction in the amount of releasing agent confined in the toner, and to a loss of uniformity in the diameter of the toner but also to an increase in the amount of the surface releasing agent during production, and which on occasions can precipitate more roll marks caused by a reduction in toner powder fluidity, at the same time a lowering of the level of glossiness during high-temperature image fixation, and consequently offsetting. On the other hand, if the maximum endothermic-peak temperature exceeds about 95° C., although production stability improves, the melt viscosity of the releasing agent is enhanced, thus lowering the melt-exudation property of releasing agent during oil-less fixing, resulting on occasions in a deterioration in the releasability of the image-fixing substrate, an inability to obtain surface smoothness, and accordingly impairing the glossiness of fixed images.

In addition, the ratio of the area of about 85° C. or less in relation to entire endothermic peak area is preferably about 5 to 15%, and more preferably about 7 to 13%. If the ratio of the area of 85° C. or less in relation to the total endothermic area is less than about 5%, the releasing agent component and the binder resin become less compatible with each other, resulting in a growth of the releasing agent domain within the toner that is larger than necessary. Thus, a releasing agent that has not been completely exuded during image fixation can remain on the fixed image, and thus precipitate a deterioration the transparency of the fixed images. On the other hand, when the ratio of the area of 85° C. or less in relation to the total endothermic area is over about 15%, the releasing agent becomes more plastic, thus lowering the melt-exudation property of the releasing agent during image fixation, impairing oil-less releasability, and occasionally preventing the formation of images with the required degree of glossiness.

The amount of the releasing agent in the toner, as determined from the maximum endothermic-peak height in differential thermal analysis, is preferably about 6 to 9% by weight and more preferably about 6.5 to 8.5% by weight. If this amount is less than about 6% by weight, the releasing agent may not be exuded in a sufficient amount for discharge during oil-less fixing, thus damaging releasability and occasionally leading to a reduction in image glossiness as a result of surface roughening. If, on the other hand, the amount of releasing agent is more than about 9%, although releasability becomes satisfactory, the presence of an increased amount of releasing agent on the toner surface may on occasions result in a higher incidence of roll marks and a diminition in powder fluidity.

The maximum peak of the releasing agent is measured by differential thermal analysis, i.e., by dissolving a toner in an organic solvent such as acetone, separating the releasing agent from the toner by means of centrifuging the resultant solution several times, drying the releasing agent thus separated, and analyzing the agent according to the method specified in ASTM D3418-8. The measurement is performed in a thermal analysis system (trade name: DSC-7, manufactured by Perkin Elmer Japan Co., Ltd.), by using the melting points of indium and zinc for temperature correction and the fusion heat of indium for calorimetric correction of the detector of the device. The measurement is performed by heating a sample on an aluminum pan, together with an empty pan as a point of reference, at a rate of increase in temperature of 10° C./min.

The releasing agent in the toner according to the invention preferably has a viscosity ηs140 of about 1.5 to 5.0 mPa·s and more preferably about 2.5 to 4.0 mPa·s. The viscosity is determined by using a type-E viscometer provided with a cone plate having a cone angle of 1.34° at 140° C. If the viscosity as determined by the type-E viscometer is less than about 1.5 mPa·s, although the melt-exudation property of the releasing agent during fixing may be satisfactory, the releasing agent layer formed on fixed images becomes uneven, often leading to irregularities in releasability and image glossiness, and on occasions to an increase in roll marks. If, on the other hand, the viscosity, as determined by the type-E viscometer, is higher than about 5.0 mPa·s, the melt-exudation property of the releasing agent may decline, resulting in unsatisfactory release. This is because during the oil-less fixing the supply of the releasing agent in an amount insufficient to ensure the release of the image-carrying substrates from the fixing rolls, and thus on occasions formation of images of a satisfactory level of glossiness.

The amount of the releasing agent present on the surface of the toner for use in the invention, as determined by X-ray photoelectron spectroscopy (XPS), is preferably about 11 to 40 atm % and more preferably about 15 to 30 atm %.

If the amount of the releasing agent present on the toner surface (amount of surface releasing agent) is less than about 11 atm %, oil-less releasability may be damaged, while if the amount is over about 40 atm %, roll marks may be generated more frequently and the fluidity of the toner may decline.

In the invention, the amount of the releasing agent present on the toner surface is quantitatively determined by using an X-ray electron spectrometer (trade name: JPS-9000MX: manufactured by JEOL. Ltd.). The total amount of carbon and oxygen derived from the resin detected and the amount of carbon derived from the releasing agent are calculated according to the following formula.
Ratio of releasing agent (%)=[(Amount of carbon detected)+(Amount of oxygen detected)]×100 (%)

Specific examples of releasing agents for use in the invention include low-molecular weight polyolefins such as polyethylene, polypropylene, and polybutene; silicones having a softening point; fatty amides such as oleic amide, erucic amide, recinoleic amide, and stearic amide; vegetable waxes such as carnauba wax, rice wax, candelilla wax, Japan tallow, and jojoba oil; animal waxes such as bee wax; mineral and petroleum waxes such as montan wax, ozokerite, ceresin, paraffin wax, microcrystalline wax, and Fischer-Tropsch wax; higher fatty acid-higher alcohol ester waxes such as stearyl stearate and behenyl behenate; higher fatty acid mono- or poly-valent lower alkyl alcohol ester waxes such as butyl stearate, propyl oleate, monostearic glyceride, distearic glyceride, and pentaerythritol tetrabehenate; higher fatty acid polyvalent alcohol multimer ester waxes such as diethylene glycol monostearate, dipropylene glycol distearate, distearic diglyceride, and tetrastearic triglyceride; sorbitan higher fatty acid ester waxes such as sorbitan monostearate; and cholesterol higher fatty acid ester waxes such as cholesteryl stearate. Among them, mineral and petroleum waxes such as paraffin waxes, microcrystalline waxes, and Fischer-Tropsch waxes, and polyalkylenes modified therefrom are preferable, as they are exuded more uniformly onto the fixed image surface during image fixation and provide the releasing agent layer with a satisfactory degree of thickness.

In the invention, these releasing agents may be used alone or in combinations of two or more.

The toner for use in the invention preferably has a toner shape factor SF1 of: 120≦SF1≦140 (wherein, toner shape factor SF1=(π/4)×(L²/A)×100; L represents the maximum length of each toner particle; and A represents the projected area of each toner particle). If the toner shape factor SF1 is less than about 120, toner may remain to an unsatisfactory degree on a photoreceptor after transfer because of inadequate cleaning by the blade. On the other hand, if the toner shape factor SF1 is more than about 140, the degree of fluidity of the toner diminishes, and thus may on occasions adversely affect the transferability of the toner from an early stage.

The toner for use in the invention preferably has at least one or more kind of metal oxide particles on the surface. These metal oxide particles not only improve the fluidity of the toner, but also at the stage of the recrystallization of the releasing agent on the fixed image surface after fixing, metal oxide particles which have migrated into the releasing agent layer inhibit the crystallizing at the releasing agent and thus have the effect of making roll marks less conscious.

Specific examples of metal oxide particles include silica, titania, zinc oxide, strontium oxide, aluminum oxide, calcium oxide, magnesium oxide, cerium oxide and mixed oxides thereof. Among them, silica and titania can be used to advantage from the viewpoints of particle diameter, grain size distribution, and productivity.

Furthermore, metal oxide particles produced by the wet method are preferable. This is because such metal oxide particles prepared by wet methods have a greater surface area and are thus capable of inhibiting crystallization to a greater extent.

As a primary particle diameter the volume average diameter of the metal oxide particles is preferably in a range of about 1 to 40 nm and more preferably in a range of about 5 to 20 nm.

Addition of metal oxide particles having an average diameter of about 50 to 500 nm is also effective in preventing crystallization and thus preferable.

These metal oxide particles or metal nitride particles may be used alone or in combinations of multiple kinds of particles. Additional amounts thereof in a toner are not particularly limited, but are preferably in a range of about 0.1 to 10% by weight and more preferably in a range of about 0.2 to 8% by weight in relation to the total amount of the toner. If the amount of the metal oxide particles added is less than about 0.1% by weight, it is difficult to obtain the effects of the metal oxide or the like which has been added, and occasionally this makes it impossible to suppress the crystallization of the releasing agent on the fixed image surface. On the other hand, if the amount added is over about 10% by weight, it is sometimes difficult to obtain the high degree of glossiness required.

Surface-treatment of these metal oxide particles for providing a hydrophobic surface thereon is advantageous, insofar that such particles can penetrate into the releasing agent layer more easily during image fixation, and suppress the crystallization of the releasing agent. Any one of the known methods may be used for the surface modification. More specifically, these methods include coupling treatments with silane, titanate, aluminate, and the like.

The coupling agent used in the coupling treatment is not particularly limited, and examples thereof which can be used to advantage include silane coupling agents such as methyltrimethoxysilane, phenyltrimethoxysilane, methylphenyldimethoxysilane, diphenyldimethoxysilane, vinyltrimethoxysilane, γ-aminopropyltrimethoxysilane, γ-chloropropyltrimethoxysilane, γ-bromopropyltrimethoxysilane, γ-glycidoxypropyltrimethoxysilane, γ-mercaptopropyltrimethoxysilane, γ-ureidopropyltrimethoxysilane, fluoroalkyltrimethoxysilane, and hexamethyldisilazane; titanate coupling agents; aluminate coupling agents.

In addition to the resin, the colorant, and the releasing agent, all described above, other components (particles) may as and when required be added to the toner for use in the invention, including internal additives, charge-controlling agents, organic particles, lubricants, and abrasives.

The internal additives may include, for example, metals such as ferrite, magnetite, reduced iron, cobalt, manganese, and nickel; the alloys thereof, magnetic derivatives of the compounds containing these metals, and the like, and may be used in contents within ranges that do not impair the electrostatic property of the toner.

The charge-controlling agent is not particularly limited, and in particular when color toners are used, colorless or pale colored compounds are preferably used. Examples thereof include quaternary ammonium salt compounds, nigrosin compounds, dyes containing complexes of aluminum, iron, chromium, and the like, and triphenylmethane pigments, and the like.

The organic particles include, for example, any particles commonly used as external additives for the toner surface such as vinyl resins, polyester resins, and silicone resins. These inorganic and organic particles may be used for purposes such as a fluidity-improving aid or a cleaning aid.

The lubricants include, for example, fatty amides such as ethylene bisstearic amide and oleic amide, and fatty acid metal salts such as zinc stearate, calcium stearate.

The abrasives include, for example, silica, alumina, and cerium oxide as described above.

When the resin, the colorant, and the releasing agent are blended, the content of the colorant is preferably about 50% by weight, or less, and more preferably in a range of about 2 to 40% by weight.

The content of other components may be any amount that does not impair the object of the invention and is normally a modest amount. Specifically, the content is preferably in a range of about 0.01 to 5% by weight and more preferably in a range of about 0.5 to 2% by weight.

The dispersion medium for the resin-particle dispersion, the colorant dispersion, and the releasing agent dispersion, and for other components according to the invention is, for example, an aqueous medium.

Aqueous media include, for example, water such as distilled water and ion-exchange water, and alcohols. These aqueous media may be used alone, or in combinations of two or more.

With regard to the grain size distribution indicator of the toner for use in the invention, the volume-average grain size distribution indicator GSDv should be no more than about 1.30, and the ratio of the volume-average grain size distribution indicator GSDv in relation to the number-average grain size distribution indicator GSDp (GSDp/GSDv) is preferably about 0.95 or more.

If the volume distribution indicator GSDv is over about 1.30, roughness on the surface of fixed images mentioned above becomes worse, causing irregularities in glossiness, and occasionally causing more roll marks in areas of high glossiness. Furthermore, if the ratio of the volume-average grain size distribution indicator GSDv in relation to the number-average grain size distribution indicator is less than about 0.95, as described above, this means an increase in the amount of smaller particle diameter toner leading to discrepancies in the amount of releasing agent contained in a single toner particle and on occasions, due to deficiensies in release, making it impossible to obtain images which have the necessary degree of glossiness.

The surface area of the toner for use in the invention is not particularly limited, and the toners having a surface area in a range of that of normal toners may be used. Specifically, when the BET method is used, the surface area, is preferably in a range of about 0.5 to 10 m²/g, more preferably in a range of about 1.0 to 7 m²/g, still more preferably in a range of about 1.2 to 5 m²/g, and particularly preferably in a range of about 1.2 to 3 m²/g.

The developer for use in the invention is not particularly limited as long as it contains the toner described above, and may contain any component composition appropriate to the application. The developer for use in the invention is a monocomponent developer if the toner is to be used alone, or a bicomponent developer if the toner and a carrier are to be used in combination.

The carrier mentioned above is not particularly limited, and examples thereof include known carriers, for example, the known resin coated carriers described in JP-A Nos. 62-39879 and 56-11461.

Specific examples of the carriers include the following resin-coated carriers. The core particles of the carriers include common iron powders, ferrite, magnetite products, and the like, and a volume-average particle diameter thereof is in a range of about 30 to 200 μm.

Examples of coating resins of the resin-coated carrier include homopolymers and copolymers from two or more monomers including: styrenes such as styrene, p-chlorostyrene, and α-methylstyrene; α-methylene fatty monocarboxylic acids such as methyl acrylate, ethyl acrylate, n-propyl acrylate, lauryl acrylate, 2-ethylhexyl acrylate, methyl methacrylate, n-propyl methacrylate, lauryl methacrylate, and 2-ethylhexyl methacrylate; nitrogen-containing acrylics such as dimethylaminoethyl methacrylate; vinyl nitriles such as acrylonitrile and methacrylonitrile; vinyl pyridines such as 2-vinylpyridine and 4-vinylpyridine; vinylethers such as vinylmethylether and vinylisobutylether; vinylketones such as vinylmethylketone, vinylethylketone, and vinylisopropenylketone; olefins such as ethylene and propylene; vinyl fluorine-containing monomers such as vinylidene fluoride, tetrafluoroethylene, and hexafluoroethylene; and additionally silicone resins containing methylsilicone, methylphenylsilicone and the like; polyesters containing bisphenol, glycol, and the like; epoxy resins, polyurethane resins, polyamide resins, cellulose resins, polyether resins, polycarbonate resins, and the like. These resins may be used alone or in combination of two or more. The amount of the coating resin is preferably in a range of about 0.1 to 10 parts by weight and more preferably in a range of about 0.5 to 3.0 parts by weight in relation to 100 parts by weight of the core particles.

A heating kneader, a heating Henschel mixer, a UM mixer, or the like may be used for production of the carrier, and additionally a heated fluidized bed, heated kiln, or the like may also be used, depending on the amount of coating resin.

Further, the mixing ratio of the toner of the invention within the developer in relation to the carrier is not particularly limited, and may be arbitrarily selected depending on the applications.

The fixing process in the invention may be a normal fixing process, and, includes, for example, the fixing processes described in JP-A Nos. 10-268662 and 10-228195. The conditions of Formulae (1) to (3) may be satisfied more easily by setting the conditions for fixing toner images onto the image-fixing substrate as follows:

More specifically, images of high glossiness can be more easily obtained by extending the length of contact time between the fixing member and the image-fixing substrate onto which toner images are transferred. Accordingly roll marks also tends to appear more easily. The nip width and the passing speed of the image-fixing substrate influence the contact time, but of the two it is the passing speed of the image-fixing substrate which is more responsible for the generation of roll marks. It would appear that the quicker the passing speed the shorter the time it takes between the release of the image-fixing substrate from the fixing member to the time of contact with the delivery roll, thus making differences in the degree of crystallization of the releasing agent easier to occur.

From the viewpoints for satisfying the conditions of Formulae (1) to (3), the contact time is preferably from about 0.025 to 0.14 seconds and more preferably from about 0.03 to 0.12 seconds. Further, the passing speed is preferably from about 40 to 200 mm/sec and more preferably from about 50 to 180 mm/sec.

The roll marks are more prevalent when, in case of paper, the glossiness of the fixed image obtained by the image forming method according to the invention is about 65 to 95%, a percentage determined according to a method specified as a testing method for 75 degrees specular glossiness of paper and board that is known in the art.

The discharging process in the invention is a process of discharging with delivery rolls the image-fixed substrate on which toner images have been fixed. The frequency of delivery roll marks occurring may vary depending on factors such as the width of the delivery roll, the pressure on the images and the temperature of the delivery roll at the time of contact with the images. Taking into account differences in temperature which occur at times that the delivery roll makes contact with the images, it is preferable to minimize variations in the occurrence of roll marks, and more specifically, for this purpose to install a heating device on the delivery roll, or a cooling device for cooling the image-fixed substrate, before it makes contact with the delivery roll.

### EXAMPLES

Hereinafter, the present invention will be described in detail with reference to Examples, but it should be understood that the invention is not limited by the Examples.

Methods of Determining Various Properties

Hereinafter, methods of determining and evaluating the toners and developers used in the Examples and Comparative Examples will be described.

Method of Determining Haze

Haze is expressed by the ratio of diffuse light transmittance (Td) to total light transmittance (Tt), (Td/Tt), and determined according to a method for determination of haze for transparent materials that is known in the art. According to this method a square test piece of 50 mm in length and width is prepared by cutting an image-carrying film (trade name: V507, manufactured by Fuji Xerox Co., Ltd.) a fixed image is formed on the test piece and the haze is determined by means of a Single-Beam Haze Computer (trade name: HZ-1, manufactured by Suga Test Instrument Co., Ltd.).

Method of Determining the Viscosity of Releasing Agents

The viscosity of releasing agents is determined by using a type-E viscometer (manufactured by Tokyo Keiki) provided with an oil-circulating constant temperature bath. The cone plate used has a cone angle of 1.34°. More specifically, the viscometer is set at a temperature of 140° C. by an empty measuring cup and the cone are placed in the measuring device, and the oil made to circulate thus maintaining the oil-circulating device at a constant temperature. After the temperature of the viscometer has stabilized, 1 g of a sample (releasing agent) is added into the measuring cup and allowed to stand for 10 minutes while the cone is kept still. After the temperature has stabilized, the viscosity is measured by rotating the cone. The rotational velocity of the cone is set at 60 rpm. Viscosities are determined three times, and an average valve is designated as the viscosity η of the releasing agent.

Method of Determining the Particle Diameter of Binder Resin Particles, Colorant Particles, and Releasing Agent Particles

The particle diameters of the binder-resin particles, the colorant particles, and the releasing-agent particles are determined by using a laser-diffraction grain size distribution-measuring device (trade name: LA-700, manufactured by Horiba, Ltd.).

Method of Determining the Particle Diameter and the Grain Size Distribution of Toners

The particle diameter and the particle diameter distribution indicator of toners are determined by using the Coulter Counter TAII (trade name, manufactured by Beckman Coulter, Inc.) and the ISOTON-II (trade name, manufactured by Beckman Coulter, Inc.) as an electrolyte. For purpose of measurement, 0.5 to 50 mg of a test sample is added, as a dispersant, to 2 ml of a 5% aqueous solution of a surfactant (sodium alkylbenzenesulfonate). The mixture is then added into 100 to 150 ml of the electrolyte mentioned above.

The sample-suspended electrolyte is dispersed in an ultrasonic dispersing machine for about one minute, and then the grain size distribution of particles having a diameter of 1.0 to 30 μm is determined by using the Coulter counter TAII mentioned above, and an aperture having a diameter of 50 μm. Volume-average and number-average distributions are thus determined. Two cumulative distribution curves of the volumes and numbers of particles respectively falling in partitioned grain ranges (channels) are drawn from the smaller side based on the grain size distributions thus obtained, and the particle diameters at a cumulative point of 16% are respectively designated as D16v and D16p, and the particle diameters at a cumulative point of 50%, D50v and D50p. In a similar manner, D84v and D84p are determined. By using these values, a volume-average grain size distribution index (GSDv) is calculated by D84v/D16v, and a number-average grain size distribution index (GSDp), by D84p/D16p.

Method of Determining the Shape Factor of Toners

The shape factor of a toner SF1 is determined by incorporating optical microscopic images of toner particles spread on the surface of a slide glass into a Luzex image-analyzing instrument via a video camcorder, measuring the maximum lengths and projected areas of 50 or more toner particles, calculating by the formula: (π/4)×(L²/A)×100 (in the formula, L is a toner maximum length, and A is a projected area), and obtaining an average.

Method of Determining the Molecular Weight and Molecular Weight Distribution of Binder Resins

The molecular weight distribution of binder resins for the toner according to the invention is determined as follows: The GPC used is HLC-8120GPC, SC-8020 (trade name, manufactured by Tosoh Corp.); the two columns used, TSK gel and Super HM-H (trade name, manufactured by Tosoh Corp. 6.0 mm ID×15 cm); and the eluant used, THF (tetrahydrofuran). The experimental conditions are as follows: sample concentration: 0.5%; flow rate: 0.6 ml/min.; sample injection: 10 μl; measurement temperature: 40° C.; and an IR detector. A calibration curve is drawn by using ten polystylene standard samples, TSK Standards A-500, F-1, F-10, F-80, F-380, A-2500, F-4, F-40, F-128, and F-700 (all trade names, manufactured by Tosoh Corp).

Method of Measuring SEM

An Hitachi Scanning Electron Microscope (trade name: S-4100, manufactured by Hitachi Ltd.) is used for measurement of the thickness of the releasing agent layer on the fixed image surface and the diameter of metal oxide particles on the surface of the toner according to the invention. For an analysis of toners, an image-fixed sample is cut into test pieces by using a diamond cutter or the like, and the test pieces, or the toner itself in a case where an image has not been fixed, are subjected to pre-treatment, by being deposited in an ion sputter (trade name: E-1030, manufactured by Hitachi Instrument Service) under a pressure of 15 Pa or less for 180 seconds. The target used therein is platinum-palladium. The method of determining the thickness of the releasing agent layer on the fixed image is as described above, and the particle diameter of the metal oxide on the toner surface is determined by selecting arbitrarily 100 metal oxide particles in a toner-surface image taken at a magnification of 30,000 fols, measuring the diameters of the metal oxide particles, and calculating on the basis of the sizes of the diameters and the degree of magnification.

Method of Calculating the Amount of Releasing Agent Added

The amount of releasing agent added into the toner according to the invention is determined as follows. The toner is dissolved in an organic solvent such as acetone, and the releasing agent is separated from the toner by repeated centrifugation or the like. The releasing agent thus separated is dried by heating and/or under reduced pressure or the like, and a weight thereof is determined according to the method specified in ASTM D3418-8. After a portion of the releasing agent has been accurately weighed, the endothermic peak thereof is determined, and a degree of heat absorbed is obtained. By changing the amount of the releasing agent several times and by determining the amount of the releasing agent and of the heat absorbed, a calibration curve is prepared and then the content of the releasing agent can be determined from the weight of the toner as determined above and the difference in the endothermic peak of the releasing agent shown in the absorption peak.

The toner according to the invention is prepared as follows. A binder resin particle dispersion, a colorant particle dispersion, a releasing agent particle dispersion, and an inorganic particle dispersion are respectively prepared, as described below. Next, to a mixed and stirred dispersion prepared from particular amounts of these dispersions, an inorganic metal salt of a polymer is added, the resultant dispersion is neutralized ionically and aggregates of the respective particles listed above formed. Binder resin particles are added before the aggregates grow to a size of toner diameter desired, and toner particle diameters. Subsequently, after by the addition of an inorganic hydroxide the pH of the system has been adjusted from the range of weakly acidic to neutral, the system is heated to a temperature of the glass transition temperature of the binder resin particles, or higher, and the toner fused. After the reaction has taken place, the result aggregates are treated by means of adequate degree of washing, solid-liquid separation, and drying, and a desired toner obtained.

Hereinafter, the preparative method will be described in detail.

(1) Preparation of Binder Resin Particle Dispersions

Preparation of Binder Resin Particle Dispersion 1

| | | |
|---|---|---|
| Oil phase | | |
| Styrene (manufactured by Wako Pure Chemical | 30 | parts by weight |
| Industries, Ltd.) | | |
| n-Butyl acrylate (manufactured by Wako Pure | 10 | parts by weight |
| Chemical Industries, Ltd.) | | |
| β-Carboxyethyl acrylate (manufactured by Rhodia | 1.1 | parts by weight |
| Nicca, Ltd.) | | |
| Acrylic acid(manufactured by Wako Pure | 0.2 | parts by weight |
| Chemical Industries, Ltd.) | | |
| Dodecanethiol (manufactured by Wako Pure | 0.4 | parts by weight |
| Chemical Industries, Ltd.) | | |
| Aqueous phase 1 | | |
| Ion-exchange water | 17.0 | parts by weight |
| Anionic surfactant (manufactured by Rhodia) | 0.39 | parts by weight |
| Aqueous phase 2 | | |
| Ion-exchange water | 40 | parts by weight |
| Anionic surfactant (manufactured by Rhodia) | 0.06 | parts by weight |
| Potassium persulfate (manufactured by Wako | 0.30 | parts by weight |
| Pure Chemical Industries, Ltd.) | | |
| Ammonium persulfate (manufactured by Wako | 0.10 | parts by weight |
| Pure Chemical Industries, Ltd.) | | |

The components of the oil phase and the components of the aqueous phase 1 are put into a flask, blended and stirred, to produce a monomer-emulsified dispersion. The components of aqueous phase 2 are then added into the reaction container, and after air in the container has been sufficiently substituted with nitrogen, and as the resultant mixture is being stirred, it is heated in an oil bath until the internal temperature of the reaction system reaches 75° C. The monomer-emulsified dispersion is gradually added into the reaction container drop by drop over a period of three hours, allowing the emulsion polymerization to proceed. After the drop by drop addition has completed, polymerization is continued for a further three hours with the reaction mixture at 75° C., and a binder resin particle dispersion 1 is thus obtained.

At the time of measurement, the binder resin particles obtained have a number-average particle diameter D₅₀ₙ of 250 nm, a glass transition point of 51.5° C., a number-average molecular weight (as polystyrene) of 13,000.

In this manner, an anionic binder resin particle dispersion 1 is obtained, containing binder resin particles having a number-average particle diameter D₅₀ₙ of 250 nm, a solid matter content of 42%, a glass transition point of 51.5° C., and a weight-average molecular weight (Mw) of 30,000.

Preparation of Binder Resin Particle Dispersion 2

Binder resin particle dispersion 2 is prepared in the same manner as in the preparation of binder resin particle dispersion 1, except insofar that in contrast to the preparation of binder resin particle dispersion 1 the amount of acrylic acid added is modified to 5.2 parts by weight and the amount of dodecanethiol added to 5.1 parts by weight.

At the time of measurement, the binder resin particles thus obtained have a number-average particle diameter D₅₀ₙ of 240 nm, a glass transition point of 52.6° C., and a number-average molecular weight (as polystyrene) of 10,000.

In this manner, an anionic binder resin particle dispersion 2 is obtained, containing binder resin particles having a number-average particle diameter D₅₀ₙ of 240 nm, a solid matter content of 41.5%, a glass transition point of 52.6° C., and a weight-average molecular weight (Mw) of 33,000.

Preparation of Binder Resin Particle Dispersion 3

Binder resin particle dispersion 3 is prepared in the same manner as in the preparation of binder resin particle dispersion 1, except insofar that in contrast to the preparation of binder resin particle dispersion 1 the amount of acrylic acid added is modified to 0.04 parts by weight and that of dodecanethiol to 0.03 parts by weight.

At the time of measurement, the binder resin particles thus obtained have a number-average particle diameter D₅₀ₙ of 180 nm, a glass transition point of 50.4° C., and a number-average molecular weight (as polystyrene) of 18,500.

In this manner, an anionic binder resin particle dispersion 3 is obtained, containing binder resin particles having a number-average particle diameter D₅₀ₙ of 180 nm, a solid matter content of 40.8%, a glass transition point of 50.4° C., and a weight-average molecular weight (Mw) of 28,500.

(2) Preparation of Colorant Dispersions

Preparation of Colorant Dispersion 1

| | | |
|---|---|---|
| Cyan pigment (copper phthalocyanine B15: 3, | 45 | parts by weight |
| manufactured by Dainichiseika Color & | | |
| Chemicals Mfg. Co., Ltd.) | | |
| Ionic surfactant (trade name: Neogen RK, | 5 | parts by weight |
| manufactured by Dai-ichi Kogyo Seiyaku Co., | | |
| Ltd.) | | |
| Ion-exchange water | 200 | parts by weight |

A mixture of the above ingredients is dispersed in a homogenizer (trade name: IKA Ultra-Turrax) for a period of 10 minutes, to produce colorant dispersion 1 containing a pigment having a volume-average particle diameter of 168 nm.

Preparation of Colorant Dispersion 2

| | | |
|---|---|---|
| Magenta pigment (PR238, manufactured by | 45 | parts by weight |
| Sanyo Color Works | | |
| Ionic surfactant (trade name: Neogen RK, | 5 | parts by weight |
| manufactured by Dai-ichi Kogyo | | |
| Seiyaku Co., Ltd.) | | |
| Ion-exchange water | 200 | parts by weight |

A mixture of the above ingredients is dispersed in a homogenizer (trade name: IKA Ultra-Turrax) for a period of ten minutes, to produce colorant dispersion 2 containing a pigment having a volume-average particle diameter of 155 nm.

Preparation of Colorant Dispersion 3

| | | |
|---|---|---|
| Magenta pigment (trade name: PR122, | 45 | parts by weight |
| manufactured by Dainichiseika | | |
| Color & Chemicals Mfg. Co., Ltd.) | | |
| Ionic surfactant (trade name: Neogen RK, | 5 | parts by weight |
| manufactured by Dai-ichi Kogyo Seiyaku Co., | | |
| Ltd.) | | |
| Ion-exchange water | 200 | parts by weight |

A mixture of the above ingredients is dispersed in a homogenizer (trade name: IKA Ultra-Turrax) for a period of ten minutes, to produce colorant dispersion 3 containing a pigment having a volume-average particle diameter of 180 nm.

Preparation of Colorant Dispersion 4

| | | |
|---|---|---|
| Yellow pigment (trade name: PY74, | 45 | parts by weight |
| manufactured by Clariant (Japan) K.K.) | | |
| Ionic surfactant (trade name: Neogen RK, | 5 | parts by weight |
| manufactured by Dai-ichi Kogyo Seiyaku Co., | | |
| Ltd.) | | |
| Ion-exchange water | 200 | parts by weight |

A mixture of the above ingredients is dispersed in a homogenizer (trade name: IKA Ultra-Turrax) for a period of ten minutes, to produce colorant dispersion 4 containing a pigment having a volume-average particle diameter of 172 nm.

(3) Preparation of an Inorganic Particle Dispersion

A mixture of 2 parts by weight of colloidal silica A (trade name: ST-OL, manufactured by Nissan Chemical Industries, Ltd., volume-average particle diameter: 40 nm) and 4 parts by weight of colloidal silica B (trade name: ST-OL, manufactured by Nissan Chemical Industries, Ltd., volume-average particle diameter: 8 nm) is appropriately prepared, 15 g of 0.02 mol/l HNO₃ are added thereto, and then 0.3 g of polyaluminum chloride are further added. The resultant mixture is left to stand and coagulate at room temperature for a period of 20 minutes, and an inorganic particle dispersion thus produced.

(4) Preparation of Releasing Agent Dispersions

Preparation of Releasing Agent Dispersion 1

| | | |
|---|---|---|
| Polyalkylene wax (trade name: FNP0092, | 45 | parts by weight |
| manufactured by Nippon Seiro | | |
| Co., Ltd., melting point: 91° C.) | | |
| Cationic surfactant (trade name: Neogen RK, | 5 | parts by weight |
| manufactured by Dai-ichi Kogyo Seiyaku Co., | | |
| Ltd.) | | |
| Ion-exchange water | 200 | parts by weight |

A mixture of the above ingredients is heated to 95° C., dispersed well in a homogenizer (trade name: Ultra-Turrax T50, manufactured by IKA), and further dispersed in a pressurized extrusion-type Gaulin homogenizer. Releasing agent dispersion 1 is thus produced, containing releasing agent particles having a volume-average particle diameter of 190 nm and a solid matter content of 24.3% by weight.

The viscosity of the releasing agent used is 3.2 mPas, as determined by an type-E viscometer. The maximum endothermic-peak temperature of the releasing agent is 91° C., as determined by differential thermal analysis, and the ratio of the endothermic area at 85° C. or lower is 11%.

Preparation of Releasing Agent Dispersion 2

| | | |
|---|---|---|
| Polyalkylene wax (trade name: FNP0100, | 45 | parts by weight |
| manufactured by Nippon Seiro | | |
| Co., Ltd., melting point: 94.7° C.) | | |
| Cationic surfactant (trade name: Neogen RK, | 5 | parts by weight |
| manufactured by Dai-ichi Kogyo Seiyaku Co., | | |
| Ltd.) | | |
| Ion-exchange water | 200 | parts by weight |

A mixture of the above ingredients is heated to 110° C., dispersed well in a homogenizer (trade name: Ultra-Turrax T50, manufactured by IKA), and further dispersed in a pressurized extrusion-type Gaulin homogenizer. Releasing agent dispersion 2 is thus produced, containing releasing agent particles having a volume-average particle diameter of 215 nm and a solid matter content of 25% by weight.

The viscosity of the releasing agent used is 4.0 mPas as determined by a type-E viscometer. The maximum endothermic-peak temperature of the releasing agent is 94.7° C., as determined by differential thermal analysis, and the ratio of the endothermic area at 85° C. or lower is 7%.

Preparation of Releasing Agent Dispersion 3

| | | |
|---|---|---|
| Polyalkylene (trade name: FNP0080, | 45 | parts by weight |
| manufactured by Nippon Seiro Co., Ltd., | | |
| melting point: 77° C.) | | |
| Cationic surfactant (trade name: Neogen RK, | 5 | parts by weight |
| manufactured by Dai-ichi Kogyo Seiyaku Co., | | |
| Ltd.) | | |
| Ion-exchange water | 200 | parts by weight |

A mixture of the above ingredients is heated to 100° C., dispersed well in a homogenizer (trade name: Ultra-Turrax T50, manufactured by IKA), and further dispersed in a pressurized extrusion-type Gaulin homogenizer. Releasing agent dispersion 3 is thus produced, containing releasing agent particles having a volume-average particle diameter of 180 nm and a solid matter content of 25% by weight.

The viscosity of the releasing agent used is 1.2 mPas, as determined by an type-E viscometer. The maximum endothermic-peak temperature of the releasing agent is 77° C., as determined by differential thermal analysis, and the ratio of the endothermic area at 85° C. or lower is 95%.

Preparation of Releasing Agent Dispersion 4

| | | |
|---|---|---|
| Polyalkylene (trade name: FT100, | 45 | parts by weight |
| manufactured by Nippon Seiro Co., Ltd., | | |
| melting point: 98° C.) | | |
| Cationic surfactant (trade name: Neogen RK, | 5 | parts by weight |
| manufactured by Dai-ichi Kogyo Seiyaku Co., | | |
| Ltd.) | | |
| Ion-exchange water | 200 | parts by weight |

A mixture of the above ingredients is heated to 113° C., dispersed well in a homogenizer (trade name: Ultra-Turrax T50, manufactured by IKA), and further dispersed in a pressurized extrusion-type Gaulin homogenizer. Releasing agent dispersion 4 is thus produced, containing releasing agent particles having a volume-average particle diameter of 190 nm and a solid matter content of 25% by weight.

The viscosity of the releasing agent used is 5.3 mPas, as determined by an type-E viscometer. The maximum endothermic-peak temperature of the releasing agent is 98° C., as determined by differential thermal analysis, and the ratio of the endothermic area at 85° C. or lower is 3%.

(5) Preparation of External Additive Toners

To 50 g of each of toners 1 to 8, 10, and 11, as described below, 1 g of hydrophobic silica (trade name: TS720, manufactured by Cabot Corporation) and 2.0 g of hydrophobic silica (trade name: X24, manufactured by Shin-Etsu Chemical Co., Ltd.) are added, and the resultant mixture is blended in a sample mill. The toners are weighed so as to become a toner concentration equivalent to 5% of a ferrite carrier which has been coated with methacrylate (manufactured by Soken Chemical & Engineering Co., Ltd.) to a degree of 1% and which has a volume-average particle diameter of 50 μm. The mixture is then stirred and mixed in a ball mill for a period of five minutes, and developers 1 to 8, 10 and 11 are thus produced.

Separately, to 50 g of the toner 9, as described below, 1 g of hydrophobic silica (trade name: TS720, manufactured by Cabot Corporation) is added, and the mixture is then blended in a sample mill. The toner is weighed so as to become a toner concentration equivalent to 5%, of a ferrite carrier which has been coated with methacrylate (manufactured by Soken Chemical & Engineering Co., Ltd.) to a degree of 1% and which has a volume-average particle diameter of 50 μm. The mixture is then stirred and mixed in a ball mill for a period of five minutes, and developer 9 is thus produced.

Production of toner 1

| | | |
|---|---|---|
| Binder resin particle dispersion 1 | 80 | parts by weight |
| Colorant dispersion 1 | 18 | parts by weight |
| Reserve aggregates of Colloidal Silica A (ST-OL | 30 | parts by weight |
| (as described)) and B (ST-OS (as described)) | | |
| Releasing agent dispersion 1 | 18 | parts by weight |
| Polyaluminum chloride | 0.36 | parts by weight |

The above ingredients are mixed and dispersed well inside a round stainless steel flask by means of a homogenizer (trade name: Ultra-Turrax T50, manufactured by IKA). Then, 0.36 parts by weight of polyaluminum chloride are added to the mixture, and the resultant mixture is further dispersed with the Ultra-Turrax. The flask is heated to 47° C. in a heating oil bath while the mixture is stirred. After the mixture has been heated at 47° C. for a period of 60 minutes, 46 parts by weight of the resin dispersion are gently added.

Then, the pH of the system is adjusted to 6.0 by addition of a 0.5 mol/l aqueous sodium hydroxide solution. The stainless steel flask is then tightly sealed and heated to 96° C. while the mixture is continuously stirred with a magnetic stirrer, and the stainless steel flask is maintained at the same temperature for a period of 3.5 hours.

After the reaction has taken place, the mixture is cooled and filtered, and the powders collected are washed thoroughly with ion-exchange water, and separated from liquid by filtration through a Nutsche filter under reduced pressure. The powders are redispersed in 3 liters of ion-exchange water at 40° C. and stirred and washed at a rotating speed of 300 rpm for a period of 15 minutes. After the above procedures has been repeated five times, when the filtrate has a pH of 7.01, an electric conductivity of 9.7 μS/cm, and a surface tension of 71.2 Nm, the powders are separated from liquid by filtration though a Nutsche filter under reduced pressure by means of a No. 5A filter. The powders are then continuously dried under vacuum for 12 hours, and toner 1 is thus produced.

Analysis of the diameters of the powders by a Coulter counter shows that the powders have a D50v of 5.8 μm, a volume-average grain size distribution indicator GSDv of 1.22, a number-average grain size distribution indicator GSDp of 1.23, and a ratio of the volume-average grain size distribution indicator GSDv, in relation to the number-average grain size distribution indicator GSDp (GSDp/GSDv), of 1.01. Further, the amount of surface releasing agent of the toner thus obtained, as determined by X-ray photoelectron spectroscopy, is 22 atm %. The amount of releasing agent in the toner, as determined from the maximum endothermic-peak height by differential thermal analysis, is 7.5%, and the ratio of the endothermic area at 85° C. or lower, in relation to the entire endothermic area, is 12%. Further, the viscosity of the releasing agent in the toner, as determined by a type-E viscometer, is 3.2 mPas.

Production of Toner 2

Toner 2 is produced in the same manner as toner 1, except insofar that, in contrast to the production of toner 1, the amount of binder resin particle dispersion 1 added is modified to 75 parts by weight, colorant dispersion 1 is replaced with colorant dispersions 2 and 3, the amount of colorant dispersion 2 added is modified to 10 parts by weight, and the amount of colorant dispersion 3 added is modified to 10 parts by weight.

Analysis of the diameters of the powders by a Coulter counter shows that the powders have a D50v of 5.76 μm, a volume-average grain size distribution indicator GSDv of 1.23, a number-average grain size distribution indicator GSDp of 1.23, and a ratio of the volume-average grain size distribution indicator GSDv, in relation to the number-average grain size distribution indicator GSDp (GSDp/GSDv), of 1.00. The amount of surface releasing agent of the toner thus obtained, as determined by X-ray photoelectron spectroscopy, is 24.5 atm %. The amount of releasing agent in the toner, as determined from the maximum endothermic-peak height by differential thermal analysis is 7.4%; and the ratio of the endothermic area at 85° C. or lower, in relation to the entire endothermic area is 13%. Further, the viscosity of the releasing agent in the toner, as determined by a type-E viscometer, is 3.4 mPas.

Production of Toner 3

Toner 3 is produced in the same manner as toner 1, except insofar that in contrast to the production of toner 1, colorant dispersion 1 is replaced with colorant dispersion 4, the amount of binder resin particle dispersion 1 added is modified to 80 parts by weight, releasing agent dispersion 1 is replaced with releasing agent dispersion 3, and the amount of the releasing agent is modified to 19 parts by weight.

Analysis of the diameters of the powders by a Coulter counter shows that the powders have a D50v of 6.00 μm, a volume-average grain size distribution indicator GSDv of 1.21, a number-average grain size distribution indicator GSDp of 1.22, and a ratio of the volume-average grain size distribution indicator GSDv, in relation to the number-average grain size distribution indicator GSDp (GSDp/GSDv), of 1.01. The amount of surface releasing agent of the toner thus obtained, as determined by X-ray photoelectron spectroscopy, is 21 atm %. The amount of releasing agent in the toner, as determined from the maximum endothermic-peak height by differential thermal analysis is 7.6%, and the ratio of the endothermic area at 85° C. or lower, in relation to the entire endothermic area, is 12.5%. Further, the viscosity of the releasing agent in the toner, as determined by a type-E viscometer, is 3.2 mPas.

Production of Toner 4

Toner 4 is produced in the same manner as toner 1, except insofar that releasing agent dispersion 1 used in production of toner 1 is replaced with releasing agent dispersion 2.

Analysis of the diameters of the powders by a Coulter counter shows that the powders have a D50v of 5.65 μm, a volume-average grain size distribution indicator GSDv of 1.20, a number-average grain size distribution indicator GSDp of 1.21, and a ratio of the volume-average grain size distribution indicator GSDv, in relation to the number-average grain size distribution indicator GSDp (GSDp/GSDv) of 1.01. The amount of surface releasing agent of the toner thus obtained, as determined by X-ray photoelectron spectroscopy, is 14 atm %. The amount of releasing agent in the toner, as determined from the maximum endothermic-peak height by differential thermal analysis, is 7.5%, and the ratio of the endothermic area at 85° C. or lower, in relation to in the entire endothermic area, is 7%. Further, the viscosity of the releasing agent in the toner, as determined by a type-E viscometer, is 4.0 mPas.

Production of Toner 5

Toner 5 is produced in the same manner as toner 1, except insofar that releasing agent dispersion 1 used in production of toner 1 is replaced with releasing agent dispersion 3.

Analysis of the diameters of the powders by a Coulter counter shows that the powders have a D50v of 5.87 μm, a volume-average grain size distribution indicator GSDv of 1.21, a number-average grain size distribution indicator GSDp of 1.23, and a ratio of the volume-average grain size distribution indicator GSDv, in relation to the number-average grain size distribution indicator GSDp (GSDp/GSDv), of 1.02. The amount of surface releasing agent of the toner thus obtained, as determined by X-ray photoelectron spectroscopy, is 42 atm %. The amount of releasing agent in the toner, as determined from the maximum endothermic-peak height by differential thermal analysis, is 7.2%, and the ratio of the endothermic area at 85° C. or lower, in relation to in the entire endothermic area, is 95%. Further, the viscosity of the releasing agent in the toner, as determined by a type-E viscometer, is 1.2 mPas.

Production of Toner 6

Toner 6 is produced in the same manner as toner 1, except insofar that releasing agent dispersion 1 used in production of toner 1 is replaced with releasing agent dispersion 4.

Analysis of the diameter of the powders by a Coulter counter showed that the powders have a D50v of 5.95 μm, a volume-average grain size distribution indicator GSDv of 1.2, a number-average grain size distribution indicator GSDp of 1.23, and a ratio of the volume-average grain size distribution indicator GSDv, in relation to the number-average grain size distribution indicator GSDp (GSDp/GSDv), of 1.03. The amount of surface releasing agent of the toner thus obtained, as determined by X-ray photoelectron spectroscopy, is 10 atm %. The amount of releasing agent in the toner, as determined from the maximum endothermic-peak height by differential thermal analysis, is 7.4%, and the ratio of the endothermic area at 85° C. or lower, in relation to in the entire endothermic area, is 3%. Further, the viscosity of the releasing agent in the toner, as determined by a type-E viscometer, is 5.3 mPas.

Production of Toner 7

Toner 7 is produced in the same manner as toner 1, except insofar that in contrast to the production of toner 1, the amount of binder resin particle dispersion 1 added is modified to 68 parts by weight and the amount of releasing agent dispersion 1 added is modified to 33 parts by weight.

Analysis of the diameters of the powders by a Coulter counter shows that the powders have a D50v of 5.72 μm, a volume-average grain size distribution indicator GSDv of 1.20, a number-average grain size distribution indicator GSDp of 1.21, and a ratio of the volume-average grain size distribution indicator GSDv, in relation to the number-average grain size distribution indicator GSDp (GSDp/GSDv), of 1.01. The amount of surface releasing agent of the toner thus obtained, as determined by X-ray photoelectron spectroscopy, is 41 atm %. The amount of releasing agent in the toner, as determined from the maximum endothermic-peak height by differential thermal analysis, is 5.6%, and the ratio of the endothermic area at 85° C. or lower, in relation to in the entire endothermic area, is 12%. Further, the viscosity of the releasing agent in the toner, as determined by a type-E viscometer, is 3.2 mPas.

Production of Toner 8

Toner 8 is produced in the same manner as toner 1, except insofar that the amount of binder resin particle dispersion 1 added is modified to 85 parts by weight and the amount of releasing agent dispersion 1 added is modified to 14 parts by weight from that in production of toner 1.

Analysis of the diameters of the powders by a Coulter counter shows that the powders have a D50v of 5.85 μm, a volume-average grain size distribution indicator GSDv of 1.20, a number-average grain size distribution indicator GSDp of 1.22, and a ratio of the volume-average grain size distribution indicator GSDv, in relation to the number-average grain size distribution indicator GSDp (GSDp/GSDv), of 1.02. The amount of surface releasing agent of the toner thus obtained, as determined by X-ray photoelectron spectroscopy, is 9 atm %. The amount of releasing agent in the toner, as determined from the maximum endothermic-peak height by differential thermal analysis, is 12.8%, and the ratio of the endothermic area at 85° C. or lower, in relation to in the entire endothermic area, is 12%. Further, the viscosity of the releasing agent in the toner, as determined by a type-E viscometer, is 3.2 mPas.

Production of Toner 9

Toner 9 similar to toner 1 is prepared. As described above, toner 9 is a toner for producing developer 9 containing only TS720 as the external additive.

Analysis of the diameter of toner 9 by a Coulter counter shows that the powders have a D50v of 5.8 μm, a volume-average grain size distribution indicator GSDv of 1.22, a number-average grain size distribution indicator GSDp of 1.23, and a ratio of the volume-average grain size distribution indicator GSDv, in relation to the number-average grain size distribution indicator GSDp (GSDp/GSDv), of 1.01. The amount of surface releasing agent of the toner thus obtained, as determined by X-ray photoelectron spectroscopy, is 20 atm %. The amount of releasing agent in the toner, as determined from the maximum endothermic-peak height by differential thermal analysis, is 7.5%, and the ratio of the endothermic area at 85° C. or lower, in relation to in the entire endothermic area, is 13%. Further, the viscosity of the releasing agent in the toner, as determined by a type-E viscometer, is 3.6 mPas.

Production of Toner 10

Toner 10 is produced in the same manner as toner 1, except insofar that binder resin particle dispersion 1 used in production of toner 1 is replaced with binder resin particle dispersion 2.

Analysis of the diameters of the powders by a Coulter counter shows that the powders have a D50v of 5.72 μm, a volume-average grain size distribution indicator GSDv of 1.21, a number-average grain size distribution indicator GSDp of 1.23, and a ratio of the volume-average grain size distribution indicator GSDv, in relation to the number-average grain size distribution indicator GSDp (GSDp/GSDv), of 1.02. The amount of surface releasing agent of the toner thus obtained, as determined by X-ray photoelectron spectroscopy, is 19 atm %. The amount of releasing agent in the toner, as determined from the maximum endothermic-peak height by differential thermal analysis, is 7.6%, and the ratio of the endothermic area at 85° C. or lower, in relation to in the entire endothermic area, is 13%. Further, the viscosity of the releasing agent in the toner, as determined by a type-E viscometer, is 3.2 mPas.

Production of Toner 11

Toner 11 is produced in the same manner as toner 1, except insofar that binder resin particle dispersion 1 used in production of toner 1 is replaced with binder resin particle dispersion 3.

Analysis of the diameters of the powders by a Coulter counter shows that the powders have a D50v of 5.85 μm, a volume-average grain size distribution indicator GSDv of 1.22, a number-average grain size distribution indicator GSDp of 1.24, and a ratio of the volume-average grain size distribution indicator GSDv, in relation to the number-average grain size distribution indicator GSDp (GSDp/GSDv), of 1.02. The amount of surface releasing agent of the toner thus obtained, as determined by X-ray photoelectron spectroscopy, is 21 atm %. The amount of releasing agent in the toner, as determined from the maximum endothermic-peak height by differential thermal analysis, is 7.4%, and the ratio of the endothermic area at 85° C. or lower, in relation to in the entire endothermic area, is 12%. Further, the viscosity of the releasing agent in the toner, as determined by a type-E viscometer, is 3.4 mPas.

### Example 1

An image is formed by using developer 1 and a modified version of a machine (trade name: Docu Centre Color 400, manufactured by Fuji Xerox Co., Ltd.) under a toner load of 13.0 g/m² on an OHP sheet (trade name: V507, manufactured by Fuji Xerox Co., Ltd.), and fixed by using an external fixing device under conditions of a nip width of 6.5 mm, a fixing speed of 180 mm/sec, and a fixing temperature of 180° C. The image-fixed OHP sheet is discharged via delivery rolls. The thickness of the releasing agent layer (releasing agent layer thickness) on the OHP-fixed image, as determined by SEM observation at 500-fold magnification, is 1.3 μm.

The haze of the OHP-fixed image in the area in contact with the delivery rolls is 8%; the haze in the area not in contact with the delivery roll is 13%; and |Ha−Hb| is 5%. The releasability of this fixing device is satisfactory, and it is confirmed that the OHP sheet can be discharged without meeting any resistance. In addition, the surface glossiness of a fixed image is 105%.

### Example 2

An image is fixed and the image-fixed OHP sheet is discharged via delivery rolls in the same manner as in Example 1 except insofar that developer 1 used in Example 1 is replaced with developer 2. The thickness of the releasing agent layer (releasing agent layer thickness) on the OHP-fixed image, as determined by SEM observation at 500-fold magnification, is 1.3 μm.

The haze of the OHP-fixed image in the area in contact with the delivery rolls is 11%; the haze in the area not in contact with the delivery roll is 15%; and |Ha−Hb| is 4%. The releasability of this fixing device is satisfactory, and it is confirmed that the OHP sheet can be discharged without meeting any resistance. In addition, the surface glossiness of a fixed image is 100%.

### Example 3

An image is fixed and the image-fixed OHP sheet is discharged via delivery rolls in the same manner as in Example 1 except insofar that developer 1 used in Example 1 is replaced with developer 2. The thickness of the releasing agent layer (releasing agent layer thickness) on the OHP-fixed image, as determined by SEM observation at 500-fold magnification, is 1.4 μm.

The haze of the OHP-fixed image in the area in contact with the delivery rolls is 16%; the haze in the area not in contact with the delivery roll is 22%; and |Ha−Hb| is 6%. The releasability of this fixing device is satisfactory, and it is confirmed that the OHP sheet can be discharged without meeting any resistance. In addition, the surface glossiness of a fixed image is 112%.

### Example 4

An image is fixed and the image-fixed OHP sheet is discharged via delivery rolls in the same manner as in Example 1 except insofar that in contrast to Example 1 the fixing temperature is modified to 160° C. The thickness of the releasing agent layer (releasing agent layer thickness) on the OHP-fixed image, as determined by SEM observation at 500-fold magnification, is 1.0 μm.

The haze of the OHP-fixed image in the area in contact with the delivery rolls is 19%; the haze in the area not in contact with the delivery roll is 23%; and |Ha−Hb| is 4%. The releasability of this fixing device is satisfactory, and it is confirmed that the OHP sheet can be discharged without meeting any resistance. In addition, the surface glossiness of a fixed image is 94%.

### Example 5

An image is fixed and the image-fixed OHP sheet is discharged via delivery rolls in the same manner as in Example 1 except insofar that in contrast to Example 1 the fixing temperature is modified to 140° C. The thickness of the releasing agent layer (releasing agent layer thickness) on the OHP-fixed image, as determined by SEM observation at 500-fold magnification, is 0.3 μm.

The haze of the OHP-fixed image in the area in contact with the delivery rolls is 27%; the haze in the area not in contact with the delivery roll is 29%; and |Ha−Hb| is 2%. The releasability of this fixing device is satisfactory, and it is confirmed that the OHP sheet can be discharged without meeting any resistance. In addition, the surface glossiness of a fixed image is 83%.

### Example 6

An image is fixed and the image-fixed OHP sheet is discharged via delivery rolls in the same manner as in Example 1 except insofar that developer 1 used in Example 1 is replaced with developer 4. The thickness of the releasing agent layer (releasing agent layer thickness) on the OHP-fixed image, as determined by SEM observation at 500-fold magnification, is 1.1 μm.

The haze of the OHP-fixed image in the area in contact with the delivery rolls is 14%; the haze in the area not in contact with the delivery roll is 18%; and |Ha−Hb| is 4%. The releasability of this fixing device is satisfactory, and it is confirmed that the OHP sheet can be discharged without meeting any resistance. In addition, the surface glossiness of a fixed image is 100%.

### Example 7

An image is fixed and the image-fixed OHP sheet is discharged via delivery rolls in the same manner as in Example 1 except insofar that developer 1 used in Example 1 is replaced with developer 5. The thickness of the releasing agent layer (releasing agent layer thickness) on the OHP-fixed image, as determined by SEM observation at 500-fold magnification, is 1.7 μm.

The haze of the OHP-fixed image in the area in contact with the delivery rolls is 3%; the haze in the area not in contact with the delivery roll is 5%; and |Ha−Hb| is 2%. The releasability of this fixing device is satisfactory, and it is confirmed that the OHP sheet can be discharged without meeting any resistance. In addition, the surface glossiness of a fixed image is 110%.

### Example 8

An image is fixed and the image-fixed OHP sheet is discharged via delivery rolls in the same manner as in Example 1 except insofar that developer 1 used in Example 1 is replaced with developer 6. The thickness of the releasing agent layer (releasing agent layer thickness) on the OHP-fixed image, as determined by SEM observation at 500-fold magnification, is 0.7 μm.

The haze of the OHP-fixed image in the area in contact with the delivery rolls is 21%; the haze in the area not in contact with the delivery roll is 28%; and |Ha−Hb| is 7%. The releasability of this fixing device is satisfactory, and it is confirmed that the OHP sheet can be discharged without meeting any resistance. In addition, the surface glossiness of a fixed image is 99%.

### Example 9

An image is fixed and the image-fixed OHP sheet is discharged via delivery rolls in the same manner as in Example 1 except insofar that developer 1 used in Example 1 is replaced with developer 7. The thickness of the releasing agent layer (releasing agent layer thickness) on the OHP-fixed image, as determined by SEM observation at 500-fold magnification, is 2.2 μm.

The haze of the OHP-fixed image in the area in contact with the delivery rolls is 11%; the haze in the area not in contact with the delivery roll is 17%; and |Ha−Hb| is 6%. The releasability of this fixing device is satisfactory, and it is confirmed that the OHP sheet can be discharged without meeting any resistance. In addition, the surface glossiness of a fixed image is 97%.

### Example 10

An image is fixed and the image-fixed OHP sheet is discharged via delivery rolls in the same manner as in Example 1 except insofar that developer 1 used in Example 1 is replaced with developer 8. The thickness of the releasing agent layer (releasing agent layer thickness) on the OHP-fixed image, as determined by SEM observation at 500-fold magnification, is 0.3 μm.

The haze of the OHP-fixed image in the area in contact with the delivery rolls is 4%; the haze in the area not in contact with the delivery roll is 6%; and |Ha−Hb| is 2%. The releasability of this fixing device is satisfactory, and it is confirmed that the OHP sheet can be discharged without meeting any resistance. In addition, the surface glossiness of a fixed image is 111%.

### Example 11

An image is fixed and the image-fixed OHP sheet is discharged via delivery rolls in the same manner as in Example 1 except insofar that developer 1 used in Example 1 is replaced with developer 9. The thickness of the releasing agent layer (releasing agent layer thickness) on the OHP-fixed image, as determined by SEM observation at 500-fold magnification, is 1.3 μm.

The haze of the OHP-fixed image in the area in contact with the delivery rolls is 6%; the haze in the area not in contact with the delivery roll is 12%; and |Ha−Hb| is 6%. The releasability of this fixing device is satisfactory, and it is confirmed that the OHP sheet can be discharged without meeting any resistance. In addition, the surface glossiness of a fixed image is 109%.

### Comparative Example 1

An image is fixed and the image-fixed OHP sheet is discharged via delivery rolls in the same manner as in Example 1 except insofar that developer 1 used in Example 1 is replaced with developer 10. The thickness of the releasing agent layer (releasing agent layer thickness) on the OHP-fixed image, as determined by SEM observation at 500-fold magnification, is 1.4 μm.

The haze of the OHP-fixed image in the area in contact with the delivery rolls is 26%; the haze in the area not in contact with the delivery roll is 32%; and |Ha−Hb| is 6%. The releasability of this fixing device is satisfactory, and it is confirmed that the OHP sheet can be discharged without meeting any resistance. In addition, the surface glossiness of a fixed image is 73%.

### Comparative Example 2

An image is fixed and the image-fixed OHP sheet is discharged via delivery rolls in the same manner as in Example 1 except insofar that developer 1 used in Example 1 is replaced with developer 11. The thickness of the releasing agent layer (releasing agent layer thickness) on the OHP-fixed image, as determined by SEM observation at 500-fold magnification, is 1.5 μm.

The haze of the OHP-fixed image in the area in contact with the delivery rolls is 1%; the haze in the area not in contact with the delivery roll is 10%; and |Ha−Hb| is 9%. The releasability of this fixing device is satisfactory, and it is confirmed that the OHP sheet can be discharged without meeting any resistance. In addition, the surface glossiness of a fixed image is 121%.

The results of the above Examples are summarized in Table 1. The delivery roll marks shown in Table 1 has been evaluated according to the following criteria:
A: |Ha−Hb|: 3% or less, no delivery roll marks are observable at all.
B: |Ha−Hb|: more than 3% and 6% or less, almost no delivery roll marks are observable.
C: |Ha−Hb|: more than 6% and 8% or less, a number of delivery roll marks are observable.

D: |Ha−Hb|: more than 8%, significant numbers of delivery roll marks are observable.

TABLE 1

| | | | | | | | | | | | | | Com- | Com- |
|---|---|---|---|---|---|---|---|---|---|---|---|---|---|---|
| | | | | | | | | | | | Exam- | Exam- | parative | parative |
| | | Exam- | Exam- | Exam- | Exam- | Exam- | Exam- | Exam- | Exam- | Exam- | ple | ple | Exam- | Exam- |
| | | ple 1 | ple 2 | ple 3 | ple 4 | ple 5 | ple 6 | ple 7 | ple 8 | ple 9 | 10 | 11 | ple 1 | ple 2 |
| Releas- | Melting point | 91 | 91 | 91 | 91 | 91 | 94.7 | 77 | 98 | 91 | 91 | 91 | 91 | 91 |
| ing | (° C.) | | | | | | | | | | | | | |
| agent | Viscosity | 3.2 | 3.4 | 3.2 | 3.2 | 3.2 | 4.0 | 1.2 | 5.3 | 3.2 | 3.2 | 3.6 | 3.2 | 3.4 |
| | (mPa · s) | | | | | | | | | | | | | |
| Toner | D50v | 5.80 | 5.76 | 6.00 | 5.80 | 5.80 | 5.65 | 5.87 | 5.95 | 5.72 | 5.85 | 5.80 | 5.72 | 5.85 |
| | GSDv | 1.22 | 1.23 | 1.21 | 1.22 | 1.22 | 1.20 | 1.21 | 1.20 | 1.20 | 1.20 | 1.22 | 1.21 | 1.22 |
| | GSDp | 1.23 | 1.23 | 1.22 | 1.23 | 1.23 | 1.21 | 1.23 | 1.23 | 1.21 | 1.22 | 1.23 | 1.23 | 1.24 |
| | GSDp/GSDv | 1.01 | 1.00 | 1.01 | 1.01 | 1.01 | 1.01 | 1.02 | 1.03 | 1.01 | 1.02 | 1.01 | 1.02 | 1.02 |
| | Ratio of | 12 | 13 | 12.5 | 12 | 12 | 7 | 95 | 3 | 12 | 12 | 13 | 13 | 12 |
| | endothermic | | | | | | | | | | | | | |
| | area at 85° C. | | | | | | | | | | | | | |
| | or lower | | | | | | | | | | | | | |
| | (releasing | | | | | | | | | | | | | |
| | agent) (%) | | | | | | | | | | | | | |
| | Amount of | 7.5 | 7.4 | 7.6 | 7.5 | 7.5 | 7.5 | 7.2 | 7.4 | 5.6 | 12.8 | 7.5 | 7.6 | 7.4 |
| | releasing agent | | | | | | | | | | | | | |
| | in toner (% by | | | | | | | | | | | | | |
| | weight) | | | | | | | | | | | | | |
| | Amount of | 22.0 | 24.5 | 21.0 | 22.0 | 22.0 | 14.0 | 42.0 | 10.0 | 41.0 | 9.0 | 20.0 | 19.0 | 21.0 |
| | releasing agent | | | | | | | | | | | | | |
| | on surface | | | | | | | | | | | | | |
| | (atm %) | | | | | | | | | | | | | |
| Fixing temperature (° C.) | | 180 | 180 | 180 | 160 | 140 | 180 | 180 | 180 | 180 | 180 | 180 | 180 | 180 |
| Thickness of releasing | | 1.3 | 1.3 | 1.4 | 1.0 | 0.3 | 1.1 | 1.7 | 0.7 | 2.2 | 0.3 | 1.3 | 1.4 | 1.5 |
| agent on fixed image | | | | | | | | | | | | | | |
| (μm) | | | | | | | | | | | | | | |
| Evalu- | Glossiness of | 105 | 100 | 112 | 94 | 83 | 100 | 110 | 99 | 97 | 111 | 109 | 73 | 121 |
| ation | fixed image | | | | | | | | | | | | | |
| result | (%) | | | | | | | | | | | | | |
| | Ha | 8 | 11 | 16 | 19 | 27 | 14 | 3 | 21 | 11 | 4 | 6 | 26 | 1 |
| | Hb | 13 | 15 | 22 | 23 | 29 | 18 | 5 | 28 | 17 | 6 | 12 | 32 | 10 |
| | \|Ha − Hb\| | 5 | 4 | 6 | 4 | 2 | 4 | 2 | 7 | 6 | 2 | 6 | 6 | 9 |
| | Delivery roll | B | B | B | B | A | B | A | C | B | A | B | * | D |
| | marks | | | | | | | | | | | | | |

* No measurement possible due to low glossiness

As is apparent from Table 1, the fixed image-carrying substrates obtained in Examples 1 to 11 exhibit fewer conspicuous delivery roll marks.

1. A toner comprising a releasing agent, a binder resin and a colorant, wherein the binder resin is contained in a form of particles, surfaces of which have 1.2 times or greater amount of a polar group-containing compound, or of a cross-linked compound, than insides thereof, and a viscosity of the releasing agent, as determined by using a type-E viscometer provided with a cone plate having a cone angle of 1.34 degrees at 140° C., is 1.5 to 5.0 mPa·S.

2. The toner according to claim 1, wherein a maximum endothermic-peak temperature of the releasing agent, as determined by differential thermal analysis, is in a range of 85 to 95° C., and a ratio of an area of components of 85° C. or lower, in relation to the entire endothermic area, as determined from the endothermic peak area, is from 5 to 15%.

3. The toner according to claim 1, wherein an amount of the releasing agent on a toner surface, as determined by X-ray photoelectron spectroscopy (XPS), is 11 to 40 atm %.

4. The toner according to claim 1, wherein an amount of the releasing agent in the toner, as determined from a peak height of the maximum endothermic peak, is 6 to 9% by weight.

5. The toner according to claim 1, wherein the releasing agent comprises at least one selected from the group consisting of a paraffin wax, a microcrystalline wax, a Fischer-Tropsch wax, and a polyalkylene that is modified therefrom.

6. The toner according to claim 1, which further comprises metal oxide particles.

7. The toner according to claim 1, which further comprises metal oxide particles having an average diameter of about 1 to 40 nm.

8. The toner according to claim 1, which further comprises metal oxide particles having an average diameter of about 1 to 40 nm and metal oxide particles having an average diameter of about 50 to 500 nm.

9. The toner according to claim 1, which further comprises metal oxide particles in an amount of 0.1 to 10% by weight in relation to the total amount of the toner.

10. The toner according to claim 1, wherein a toner shape factors SF1 represented by the following formula is in a range of 120 to 140;
SF1=(L²/A)×(π/4)×100
wherein L represents the maximum length of each toner particle; and A represents the projected area of each toner particle.

11. The toner according to claim 1, wherein surface area of the toner, as determined by the BET method, is in a range of about 0.5 to 10 m²/g.

12. The toner according to claim 1, wherein the volume-average grain size distribution indicator GSDv is no more than about 1.30, and the ratio of the volume-average grain size distribution indicator GSDv in relation to the number-average grain size distribution indicator GSDp (GSDp/GSDv) is about 0.95 or more.

13. A developer containing a carrier and a toner comprising a releasing agent, a binder resin and a colorant, wherein the binder resin is contained in a form of particles, surfaces of which have 1.2 times or greater amount of a polar group-containing compound, or of a cross-linked compound, than insides thereof, and a viscosity of the releasing agent, as determined by using a type-E viscometer provided with a cone plate having a cone angle of 1.34 degrees at 140° C., is 1.5 to 5.0 mPa·S.

14. The developer according to claim 13, wherein the carrier comprises a core particle and a coating resin, and an amount of the coating resin is in a range of about 0.1 to 10 parts by weight in relation to 100 parts by weight of the core particle.

15. An image forming method comprising:
transferring a toner image onto an image-fixing substrate by using a developer containing a toner having a releasing agent, a binder resin and a colorant;
fixing the transferred toner image; and
discharging the fixed toner image-carrying substrate with delivery rolls, wherein
the binder resin is contained in a form of particles, surfaces of which have 1.2 times or greater amount of a polar group-containing compound, or of a cross-linked compound, than insides thereof;
a viscosity of the releasing agent, as determined by using a type-E viscometer provided with a cone plate having a cone angle of 1.34 degrees at 140° C., is 1.5 to 5.0 mPa·S; and
a haze Ha of a toner image which is brought into contact with the delivery rolls during the discharging, and a haze Hb of a toner image which is not brought into contact with the delivery rolls during the discharging, satisfy the following Formulae (1) to (3):
0.3%≦Ha≦30%; Formula (1)
0.3%≦Hb≦30%; and Formula (2)
0<|Ha−Hb|≦8%. Formula (3)

16. The method according to claim 1, wherein a length of contact time between the fixing member and the image-fixing substrate onto which the toner image is transferred is from 0.025 to 0.14 seconds.
